(19) United States
(12) Patent Application Publication
(10) Pub. No.: US 2025/0068983 A1
(43) Pub. Date: Feb. 27, 2025

(54) PSEUDO-LABELLING BASED BOOTSTRAPPING FOR SEMI SUPERVISED LEARNING

(71) Applicant: Oracle International Corporation, Redwood Shores, CA (US)

(72) Inventors: Olaitan Olaleye, Millburn, NJ (US); Hitesh Laxmichand Patel, Jersey City, NJ (US); Tao Sheng, Bellevue, WA (US)

(73) Assignee: Oracle International Corporation, Redwood Shores, CA (US)

(21) Appl. No.: 18/237,234

(22) Filed: Aug. 23, 2023

(51) Int. Cl. G06N 20/20

(52) U.S. Cl. CPC G06N 20/20

(57) ABSTRACT

In some implementations, the techniques may include receiving an accuracy target for one or more machine learning models. In addition, the techniques may include training the models on a labeled training set of labeled data. The techniques may include, until the accuracy of the models satisfies the accuracy target: sampling, a set of unlabeled data to obtain a random training set of unlabeled data; labeling the random training set of unlabeled data using the models to produce a pseudo labeled training set; correcting the labels on a random subset of the pseudo labeled training set; training the models on the labeled training set, the corrected random subset, and the pseudo labeled training set; and evaluating the accuracy of the models using an evaluation set of labeled data. The one or more models can be deployed based at least in part on the models satisfying the accuracy target.

### BACKGROUND

Machine learning models can be trained to categorize entities such as objects in images. Training these machine learning models can require data with labels identifying the entities' category. Sourcing labeled data can be problematic because a large number of data may be needed to train a model, and manually labeling entities can be time consuming and expensive. Accordingly, improvements to training machine learning models are desirable.

### BRIEF SUMMARY

In one general aspect, techniques may include receiving, by a computing device, an accuracy target for one or more machine learning models. The techniques may also include training, by the computing device, the one or more machine learning models on a labeled training set of data. The techniques may furthermore include until the accuracy of the one or more machine learning models satisfies the accuracy target: sampling, by the computing device, a set of unlabeled data to obtain a random training set of unlabeled data; labeling, by the computing device and using the one or more machine learning models, the random training set of unlabeled data to produce a pseudo labeled training set; correcting, by the computing device, the labels on a random subset of the pseudo labeled training set; training, by the computing device, the one or more machine learning models on the labeled training set, the corrected random subset, and the pseudo labeled training set; and evaluating, by the computing device, the accuracy of the one or more machine learning models using an evaluation set of labeled data. The techniques may include deploying, by the computing device, the one or more machine learning models based at least in part on the accuracy of the one or more machine learning models satisfying the accuracy target based at least on the evaluating. Other embodiments of these techniques include corresponding methods, computer systems, apparatus, and computer programs recorded on one or more computer storage devices, each configured to perform the actions of the techniques.

Implementations may include one or more of the following features. Techniques where the accuracy target may include a threshold determined based at least in part on a performance of the one or more machine learning models in classifying unlabeled data. Techniques where the labeling may include ensemble learning with multiple machine learning models. Techniques where ensemble learning may include at least one of bagging, stacking, or boosting. Techniques where the labeling may include test time augmentation with at least one of vertical/horizontal flipping, blurring, random cropping, or histogram equalization. Techniques where the evaluating further may include: identifying a performance deficiency where the accuracy of the one or more models in classifying a class of unlabeled data is below a threshold; and augmenting the random subset of the pseudo labeled training set with a targeted subset having data from the pseudo labeled training set that are labeled with the class. Techniques where the labeled training set of labeled data is smaller than the pseudo labeled training set so that a small amount of labeled data can be used to create a larger pseudo labeled training set. Implementations of the described techniques may include hardware, a method or process, or a computer tangible medium.

### BRIEF DESCRIPTION OF THE DRAWINGS

FIG. 1 is a simplified diagram of bagging according to at least one embodiment.

FIG. 2 is a simplified diagram of boosting according to at least one embodiment.

FIG. 3 shows a simplified diagram of stacking according to at least one embodiment.

FIG. 4 shows a simplified diagram of a system for training a machine learning model according to at least one embodiment.

FIG. 5 shows a simplified diagram and flow chart for training a machine learning model according to at least one embodiment.

FIG. 6 depicts a machine learning model according to at least one embodiment.

FIG. 7A shows an example machine learning model of a neural network to at least one embodiment.

FIG. 7B shows an example machine learning model of a support vector machine (SVM) to at least one embodiment.

FIG. 8 shows a technique for training a machine learning model according to at least one embodiment.

FIG. 9 is a block diagram illustrating one pattern for implementing a cloud infrastructure as a service system, according to at least one embodiment.

FIG. 10 is a block diagram illustrating another pattern for implementing a cloud infrastructure as a service system, according to at least one embodiment.

FIG. 11 is a block diagram illustrating another pattern for implementing a cloud infrastructure as a service system, according to at least one embodiment.

FIG. 12 is a block diagram illustrating another pattern for implementing a cloud infrastructure as a service system, according to at least one embodiment.

FIG. 13 is a block diagram illustrating an example computer system, according to at least one embodiment.

### DETAILED DESCRIPTION

In the following description, various embodiments will be described. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described.

Embodiments of the present disclosure provide techniques for generating pseudo-labeled datasets for training machine learning models. These datasets can be labeled using ensemble learning where multiple individual models are combined to produce an aggregate model. A group of individual models can be trained on a small, labeled dataset, and once trained, the individual model can be combined to produce an ensemble model. This ensemble model can be used to pseudo-label a subset from a larger unlabeled dataset. This subset can be produced via bootstrapping, and, in addition, the labels of a sample from the pseudo-labeled subset can be corrected by a human. The ensembled model can then be trained on the labeled data, the pseudo-labeled dataset, and the corrected sample. Once trained, the ensembled model can be evaluated. This technique is repeated to recursively train the ensembled model until the model's accuracy is above an accuracy threshold.

Machine learning models can be trained to classify entities using semi-supervised learning techniques. The entities can be objects or persons depicted in an image and the classification can be a label that is assigned to the entity. This classification task has two parts: identifying objects in the image and assigning a label to the objects. In supervised learning, the models can be trained with labeled data. This data consists of images where a human has identified entities and assigned classifications. However, models may require large number of labeled images and it may not be practical or possible to manually label sufficient images to produce a training data set. In semi-supervised learning, an initial labeled training data set is used to train a model which can then assign classifications to unlabeled data (e.g., unlabeled images). Training data with labels that were assigned by a model are known as pseudo-labeled training data. Semi-supervised learning techniques that use pseudo-labeled data can train a model with significantly fewer labeled training samples (e.g., data that was labeled by a human) than would be required for supervised learning.

Sourcing appropriate datasets can be challenging because of the amount of data required to train a model. Even obtaining sufficient unlabeled data can be problematic, but this difficulty can be mitigated using bootstrapping techniques. With bootstrapping, the unlabeled data can be obtained as subsets from a larger dataset. In bootstrapping, a dataset is randomly sampled to produce a subset. This random sampling process is repeated so that a single dataset can be used to create a large number of simulated samples (e.g., subsets). Each subset can be sampled from the same dataset and the data corresponding to a subset may not be removed between samples.

Ideally, a machine learning model that is trained on a particular dataset can learn to properly classify both the training dataset and new data. However, models that perform well on training data may make errors when encountering new datasets, and this can be particularly true for models trained on small datasets. These classification errors can be caused by variance or bias. Variance is when the model has overfit the training data and the model has learned the training data's characteristics too closely. Such a model can classify the training data well, but the model may struggle to classify new datasets. Bias is when the model has underfit the training data and the model has not learned the correct lessons from training. Biased models may classify training data with lower accuracy than a model with high variance, but a biased model may be better at classifying new datasets than a model with high variance. Bias and variance are inversely correlated with bias increasing as variance decreases while variance increases as bias decreases.

The bias or variance of an individual model can be corrected using ensemble learning techniques. Ensemble learning involves combining individual machine learning models into an aggregated model. The individual models can be aggregated using different techniques that can compensate for the limitations of the different models, and the aggregated model may be more accurate than any of its constituent models. For instance, some ensemble learning techniques may produce an aggregate model that has higher variance than its constituent models. Alternatively, some ensemble learning techniques can lead to an aggregate model that has higher bias than its constituent parts.

Combining the models to produce an aggregate model can mean combining the output of individual models or combining the actual models to produce a meta-model. For example, bagging is a technique where the outputs of several high variance models are averaged to make predictions with lower variance than the predictions from the individual models (e.g., constituent models). Boosting is an ensemble learning technique where the individual models are trained sequentially and combined to produce a meta-model. The datasets are updated after each model is trained so that the next model in the sequence pays more attention to the data that the previous model struggled to classify. Boosting can produce an aggregate model with less bias than the constituent models. Also, another ensemble learning technique, stacking, involves combining several models to produce a meta-model with less bias than the individual models.

An ensembled model can be used to assign pseudo-labels to an unlabeled dataset. The robustness of the pseudo-labels can be improved using various techniques. For example, the images from the unlabeled dataset can be modified and the prediction for each modified image can be averaged. This process, called test time augmentation, takes the average of each prediction as the classification for the unmodified image mitigating the possibility that the model overfits the data. In an additional example, duplicate detections of objects in an image can be reduced using non-maximum suppression where overlapping bounding boxes (e.g., boxes surrounding a detected object that is assigned a classification) are removed. Non-maximum suppression can be class dependent, where only bounding boxes from the same class are removed, or class agnostic where overlapping bounding boxes are removed regardless of class. In another example, a subsample of the pseudo-labeled samples can be evaluated by a human and any incorrect classifications can be corrected. In another example, the training data can be supplemented with additional labeled data for a particular class that is underperforming (e.g., with an accuracy score below a threshold).

These techniques can be combined to train a model using relatively small datasets. In an illustrative example, a customer wants a model that can identify fire hydrants in images. The customer provides a relatively small dataset of images with labeled fire hydrants, and this dataset is used to train a model to identify fire hydrants in unlabeled images. After this training, the model is ensembled (e.g., combined) with other previously trained models and this ensembled model is used to pseudo label a sample from a large unlabeled dataset by identifying fire hydrants in the unlabeled sample. A percentage (e.g., 3%-5%) of this pseudo labeled sample can be corrected by a human and a model can be trained on the labeled data, the pseudo-labeled sample, and the corrected pseudo labeled data. The performance of the model can be evaluated and, if the model exceeds an accuracy threshold, the model can be deployed.

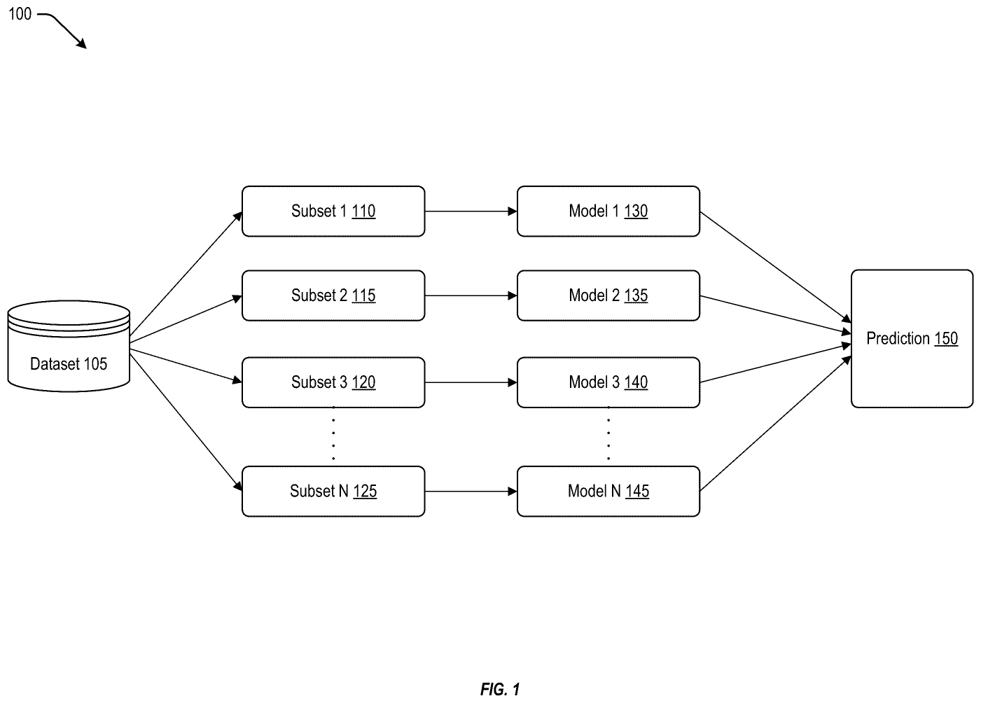

FIG. 1 is a simplified diagram 100 of bagging according to at least one embodiment. A training dataset 105 can be sampled to produce one or more subsets such as subset 1 110, subset 2 115, subset 3 120, and subset N 125. These samples can be separate individual samples that are drawn from the dataset 105 or one or more of the samples may be repeated. The samples can be generated using bootstrapping techniques or any other sampling technique that results in a sample that is representative of the dataset. Data in each sample may be distinct with each sample including separate data or the data between samples may overlap in part. Each data set can be used to train a model, and, for example, subset 1 110 can be used to train model 1 130, subset 2 115 can be used to train model 2 135, subset 3 120 can be used to train model 3 140, and subset N can be used to train model N 145. The subsets may be generated from dataset 105 using bootstrapping techniques.

In bagging, the models can be ensembled by combining the output of each model to produce an aggregated prediction 150. The output of a model can be a probability that an area in an image contains an entity that should be assigned a classification (e.g., a car, a boat, a person, a dog, a crosswalk, etc.). An entity can be assigned one or more different classifications, and, for example, a car may be classified as a vehicle and as a car. In some embodiments, each type of classification that can be assigned to an entity can be a class. The probabilities output from each model can be averaged and the averaged probability can be the output from the ensembled model. The averaged output can have a smaller variance than the output from the individual models.

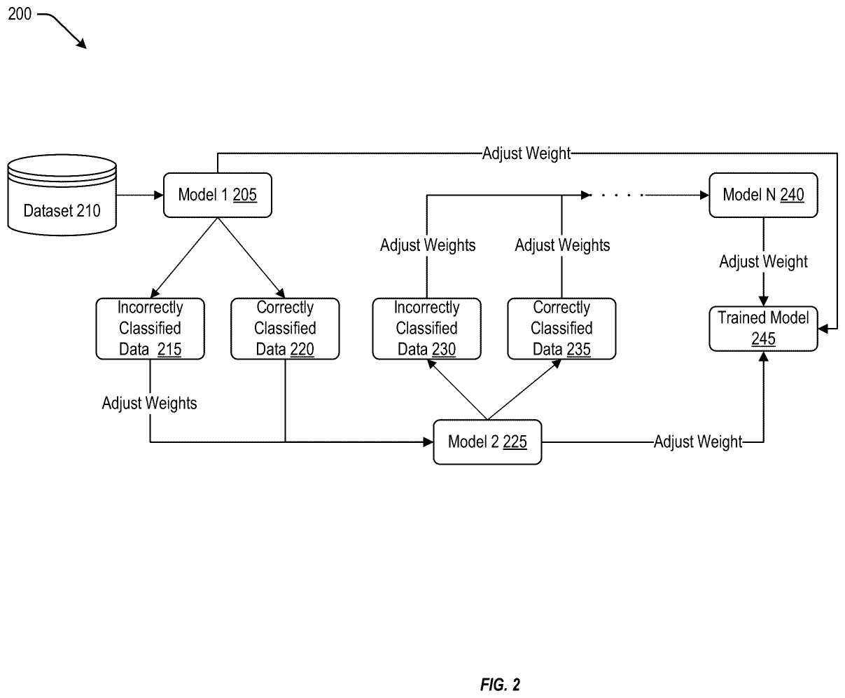

FIG. 2 is a simplified diagram 200 of boosting according to at least one embodiment. In boosting, weights are assigned to data in a training dataset and models are trained sequentially on the dataset. Between training sessions, the weights are increased for data that was not accurately classified in the previous training session so that difficult to classify data receives more attention in the next training session. For example, model 1 205 can be trained on data sampled from dataset 210. During training, model 1 205 can classify the data from dataset 210 and the data can be divided into incorrectly classified data 215 and correctly classified data 220. This data can be provided to the subsequent model (e.g., model 2 225). The weights for the incorrectly classified data 215 can be increased so that model 2 225 gives greater attention to the incorrectly classified data 215 during the next round of training.

Model 2 225 can classify the data used to train model 1 205 (e.g., incorrectly classified data 215 and correctly classified data 220). After model 2 225 is trained, the data can be sorted into incorrectly classified data 230 and correctly classified data 235. For example, the data can be manually checked and sorted into the correct and incorrect categories. After the data has been separated, the weights for the incorrectly classified data 230 and the correctly classified data 235 can be adjusted. Model 2 225 may classify data with a different accuracy than model 1 205 and incorrectly classified data 215 and incorrectly classified data 230 may contain different data. Accordingly, the weights for correctly classified data 235 and incorrectly classified data 230 may need to be adjusted to reflect the performance of model 2 225.

The training and adjustment process can proceed for any number of models. Model N 240 can be the last model trained during the technique shown in diagram 200, and model N 240 can be combined with model 1 205 and model 2 225 to produce a trained model 245. Each model that is included in trained model 245 can be assigned a weight based on the model's accuracy in classifying the data. This weighting procedure can allow more accurate models to have more influence in the trained model 245 while less accurate models can have less influence.

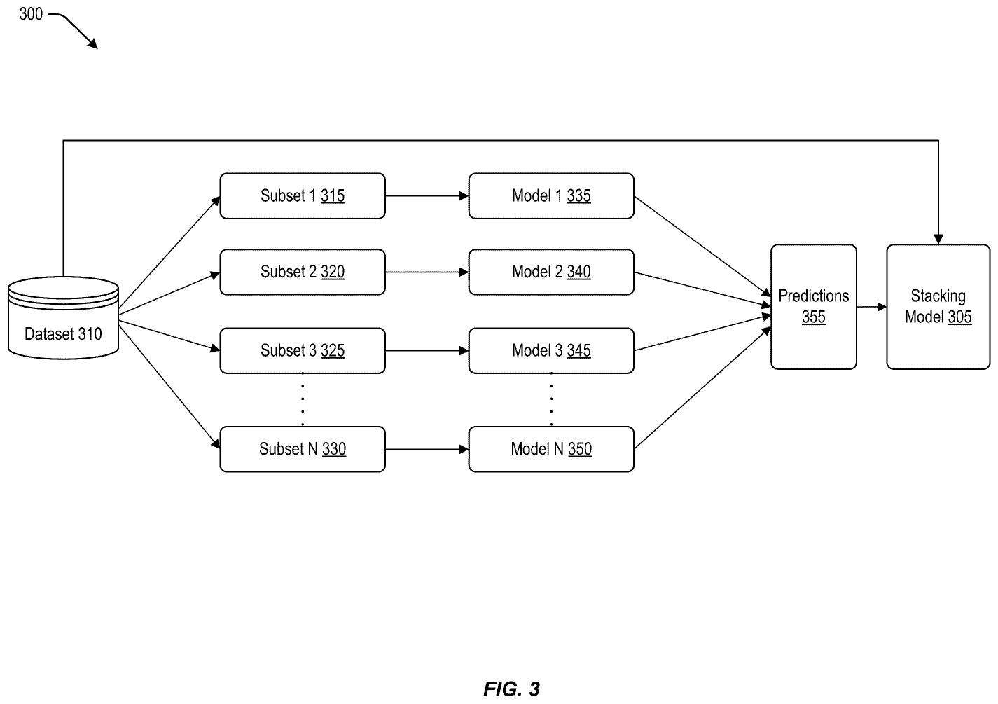

FIG. 3 shows a simplified diagram 300 of stacking according to at least one embodiment. Stacking involves training a stacking model 305 on the outputs of other models. For example, dataset 310 can be divided into subsets such as subset 1 315, subset 2 320, subset 3 325, and subset N 330. While four subsets, and models, are shown, stacking can be performed with any number of subsets or models. The subsets can be created from dataset 310 using bootstrapping techniques and the subsets may contain the same data, overlapping data, or separate data.

The subsets can be used to train models. For instance, subset 1 315 can be used to train model 1 335, subset 2 320 can be used to train model 2 340, subset 3 325 can be used to train model 3 345, and subset N 330 can be used to train model N 350. The predictions 3550 output from these models is then used, along with data from dataset 310, to train the stacking model 305. The machine learning models can be different types of models. For instance, model 1 335, model 2 340, model 3 345, and model N 350 can each be different model types.

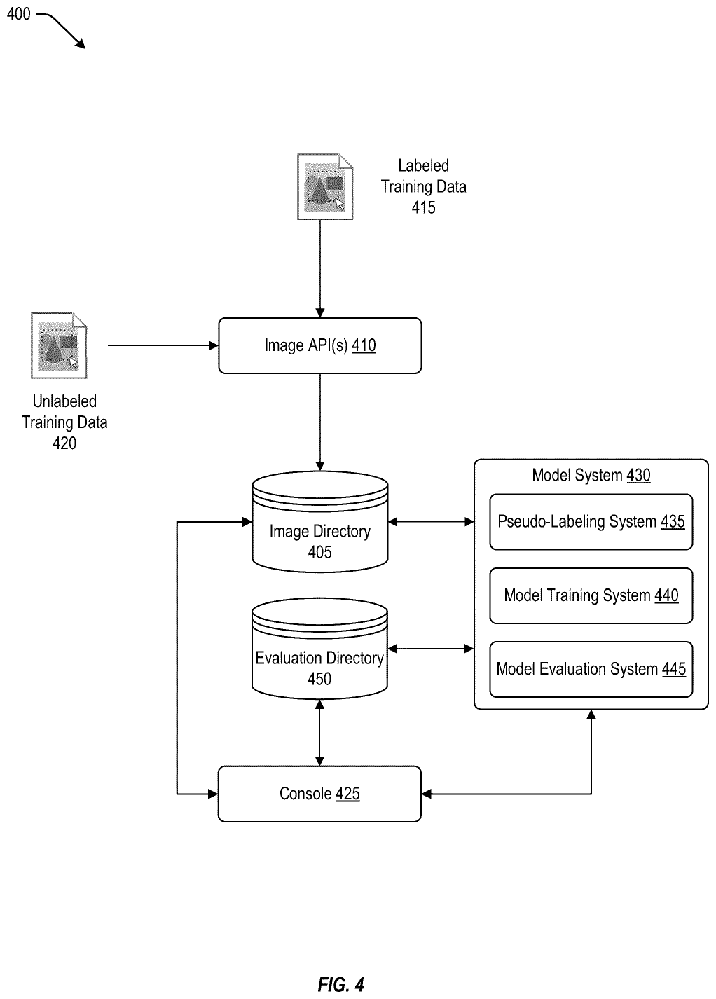

FIG. 4 shows a simplified diagram 400 of a system for training a machine learning model according to at least one embodiment. Training data can be stored in an image directory 405. The image data can include images that are provided via image application programming interfaces (APIs) 410. This training data can include labeled training data 415 or unlabeled training data 420. Unlabeled training data 420 can consist of images without any identified entities such as a person or object that is visible in the image. Labeled training data can be any image with an identified entity in the image. The identified entity can be marked with a graphic surrounding the identified object and a label with the classification for the entity. The graphic surrounding the object can be a bounding box (e.g., a rectangle or square around the object). The image directory can be controlled or edited via the console 425. A user can use the console 425 to delete images, label images, generate a training set of images, generate a validation set of images, and the like.

The model system 430 can be used to train a model using the images in the image directory 405. The model system 430 can be controlled using the console 425, and, for instance, the type of model being trained, and the techniques used to train the model, can be provided to the model system 430 using the console 425. The pseudo-labeling system 435 in model system 430 can be used to assign labels to unlabeled training data 420 in image directory 405. Console 425 can be used to select one or more models that are used to assign pseudo-labels, the number of images that are to be pseudo-labeled, and the specific label categories that are to be assigned to the images.

The model training system 440 can train a model using data from the image directory 405. The console 425 can be used to control training by the model training system 440 by identifying the one or more models that are to be trained, and the training techniques that are used to train the one or more models. In addition, the console 425 can be used to specify characteristics of the training data such as the size of the training dataset, the validation dataset, and the test dataset. During or after the training, the model's performance can be evaluated using the model evaluation system 445 using validation datasets and training datasets. Results from this training can be stored in an evaluation directory 450. Image directory 405 and evaluation directory 450 are shown in diagram 400 as a single directory, but multiple directories are contemplated in various embodiments.

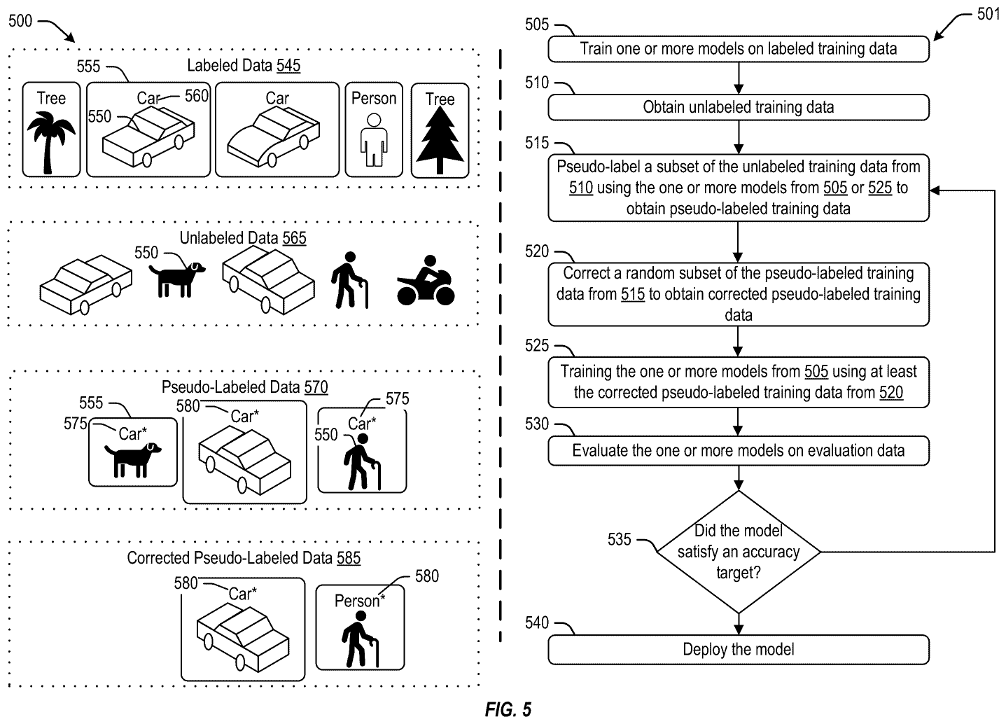

FIG. 5 shows a simplified diagram 500 and flow chart 501 for training a machine learning model according to at least one embodiment. This technique is illustrated as a logical flow diagram, each operation of which can be implemented in hardware, computer instructions, or a combination thereof. In the context of computer instructions, the operations may represent computer-executable instructions stored on one or more computer-readable storage media that, when executed by one or more processors, perform the recited operations. Generally, computer-executable instructions include routines, programs, objects, components, data structures and the like that perform particular functions or implement particular data types. The orders in which the operations are described are not intended to be construed as a limitation, and any number of the described operations can be combined in any order and/or in parallel to implement the processes or the method.

Turning to flow chart 501 in greater detail, at block 505 one or more models can be trained on labeled data 545. The labeled data can include an identified entity 550, a bounding box 555 surrounding the entity, and a label 560. This labeled data 545 can be divided into training data, test data and validation data. During training, the model is trained on the test data and evaluated on the validation dataset. Once the model's performance on the validation dataset is above a threshold, the training can end, and the model's performance can be tested on the test dataset to determine the model's ability to classify data that has not been presented to the model during training. If the model's performance (e.g., classification accuracy) is above a threshold, the technique can proceed to block 510. If the model's performance is below a threshold, the model may be retrained or a different model may be trained until a model that satisfies the performance threshold is trained.

At block 510, unlabeled training data 565 can be obtained. The unlabeled training data 565 can include images with entities 550, but the unlabeled training data 565 may not include bounding boxes 555 or labels 560. In some embodiments, the unlabeled training data 565 can include labels for categories that are not the subject of the current training. For instance, a model may be undergoing training to produce a model that can label cats in images and the unlabeled training data may include labels for trees but no cat labels.

At block 515, a subset of the unlabeled training data 565 from block 510 can be pseudo-labeled using the one or more machine learning models that were trained at block 505, or the one or more models that were trained at block 525. Pseudo-labeling can be when a model assigns labels to entities 550 and pseudo-labeling can produce pseudo-labeled data 570. A model can pseudo-label an entity 550 by identifying the entity, placing a bounding box 555 around the entity and classifying the entity with an inaccurate pseudo-label 575 or an accurate pseudo-label 580.

At block 520, a random subset of the pseudo-labeled training data from block 515 can be revised to produce corrected pseudo-labeled data 585. Corrected pseudo-labeled data 585 can be data that was incorrectly labeled by a machine learning model but the inaccurate pseudo-label 575 was manually changed to an accurate pseudo-label. The random subset can include some or all of the pseudo-labeled data.

At block 525, the one or more models from 505 can be trained on at least the corrected pseudo-labeled training data from 520. The one or more models trained at 525 can include some or all of the models from 505 as well as one or more new models in addition to some or all of the models from 505. In some embodiments, entirely new models are trained at 525 without any of the models from 505. The models trained at 525 can be trained on one or more of labeled data 545, unlabeled training data 565, pseudo-labeled data 570, and corrected pseudo-labeled data 585.

At block 530, the models trained at 525 can be evaluated on evaluation data. The evaluation data can be labeled data 545 that was not used to train the models at 525. The models can be used to classify the evaluation data and the classifications assigned by the models can be compared to the labels 560 to determine the accuracy of the trained models (e.g., model accuracy).

At block 535, whether the model satisfies an accuracy target can be determined. The accuracy target can be based on the model's performance on the evaluation data at 525. The accuracy targets can be based on one or more accuracy metrics including classification accuracy, logarithmic loss, confusion matrix, area under curve, F1 score, mean absolute error, mean squared error, or any other accuracy metrics. If the model satisfies the accuracy target (e.g., the model's classification accuracy is above 85%), the one or more models evaluated at 530 are ready to be deployed and the technique illustrated by flow chart 501 can proceed to block 540. If the one or more models evaluated at 530 do not satisfy the accuracy target, the technique illustrated by flow chart 501 can return to block 515 and the models can be used to pseudo label unlabeled training data.

An entire set of training samples can be split into a training set and a test set. The test set is not used during the training and will be used later to evaluate if the model, developed only with the training set, makes accurate predictions. If the model accurately categorizes the validation set, the model can be extended to categorize new data sets. Once the model is trained, a new input vector (e.g., a new service) can be classified, (e.g., deployment characteristics can be suggested for the new service). At block 540, the one or more models that satisfy the accuracy target at 535 can be deployed.

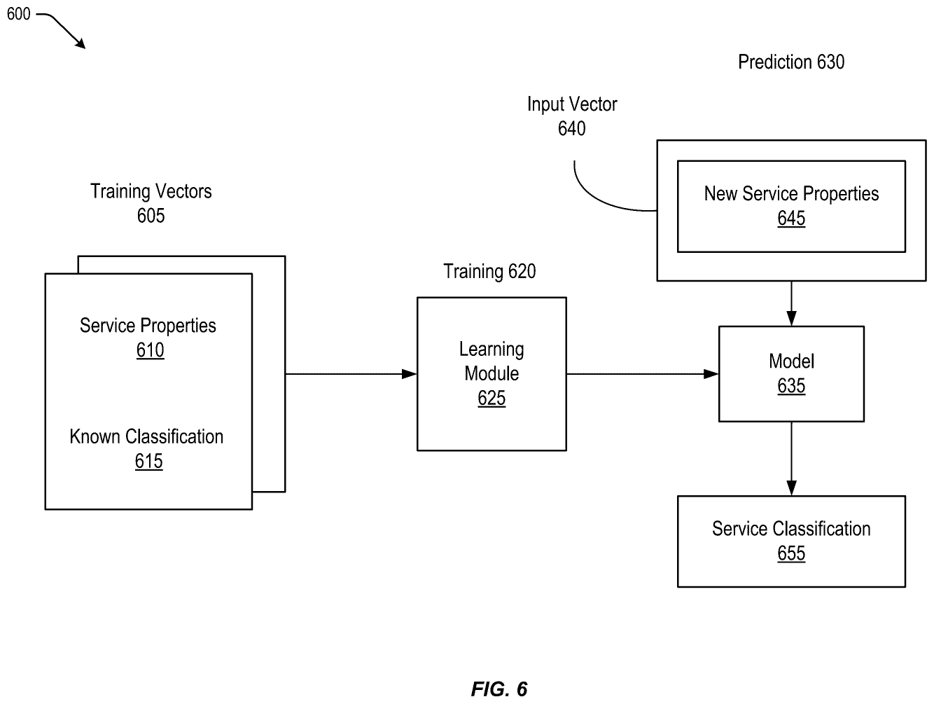

FIG. 6 depicts a machine learning model according to the embodiments of the present invention. Training vectors 605 are shown with service properties 610 and a known classification 615. As examples, a service can be a machine learning model that can be deployed to a cloud network. Service properties 610 can include various fields. For ease of illustration, only two training vectors are shown, but the number of training vectors may be much larger, e.g., 10, 60, 100, 1,000, 10,000, 100,000, or more. Training vectors could be made for different services, the same service over different time periods.

Service properties 610 have property fields that can correspond to properties of a machine learning model or cloud service and the skilled person will appreciate the various ways that such services or models can be configured. Known classifications 615 include hardware or software characteristics such as the number of nodes, the number of central processing unit (CPU) cores, the number of graphical processing units (GPUs), the number of CPUs, the type of CPUs, the type of CPUs, the amount of memory, and the like. The classification can have arbitrary support (e.g., a real number) or be an element of a small finite set. The classification can be ordinal, and thus the support can be provided as an integer. Accordingly, a classification can be categorical, ordinal, or real, and can relate to a single measurement or multiple measurements and may be high dimensional.

Training vectors 605 can be used by a learning module 625 to perform training 620. Learning module 625 can optimize parameters of a model 635 such that a quality metric (e.g., accuracy of model 635) is achieved with one or more specified criteria. The accuracy may be measured by comparing known classifications 615 to predicted classifications. Parameters of model 635 can be iteratively varied to increase accuracy. Determining a quality metric can be implemented for any arbitrary function including the set of all risk, loss, utility, and decision functions.

In some embodiments of training, a gradient may be determined for how varying the parameters affects a cost function, which can provide a measure of how accurate the current state of the machine learning model is. The gradient can be used in conjunction with a learning step (e.g., a measure of how much the parameters of the model should be updated for a given time step of the optimization process). The parameters (which can include weights, matrix transformations, and probability distributions) can thus be optimized to provide an optimal value of the cost function, which can be measured as being above or below a threshold (i.e., exceeds a threshold) or that the cost function does not change significantly for several time steps, as examples. In other embodiments, training can be implemented with methods that do not require a hessian or gradient calculation, such as dynamic programming or evolutionary algorithms.

A prediction stage 630 can provide a predicted entity classification 655 for a new entity's entity signature vector 640 based on new service properties 645. The new service properties can be of a similar type as service properties 610. If new service properties are of a different type, a transformation can be performed on the data to obtain data in a similar format as service properties 610. Ideally, predicted service classification 1055 corresponds to the true service classification for input vector 640.

Examples of machine learning models include deep learning models, neural networks (e.g., deep learning neural networks), kernel-based regressions, adaptive basis regression or classification, Bayesian methods, ensemble methods, logistic regression and extensions, Gaussian processes, support vector machines (SVMs), a probabilistic model, and a probabilistic graphical model. Embodiments using neural networks can employ using wide and tensorized deep architectures, convolutional layers, dropout, various neural activations, and regularization steps.

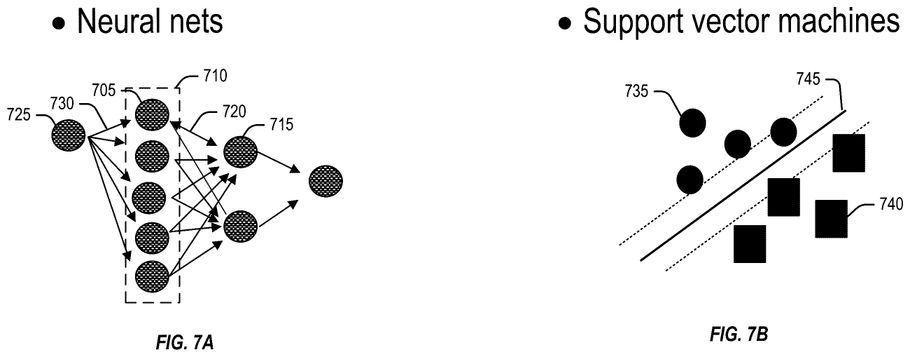

FIG. 7A shows an example machine learning model of a neural network. As an example, model 735 can be a neural network that comprises a number of neurons (e.g., Adaptive basis functions) organized in layers. For example, neuron 705 can be part of layer 710. The neurons can be connected by edges between neurons. For example, neuron 705 can be connected to neuron 715 by edge 720. A neuron can be connected to any number of different neurons in any number of layers. For instance, neuron 705 can be connected to neuron 725 by edge 730 in addition to being connected to neuron 715.

The training of the neural network can iteratively search for the best configuration of the parameter of the neural network for feature recognition and classification performance. Various numbers of layers and nodes may be used. A person with skills in the art can easily recognize variations in a neural network design and design of other machine learning models.

FIG. 7B shows an example machine learning model of a support vector machine (SVM). As another example, model 735 can be a support vector machine. Features can be treated as coordinates in a coordinate space. Samples of training data points (e.g., multidimensional data points composed of the measured data). The training data points are distributed in the space, and the support vector machine can identify boundaries between the classifications. For example point 735 and point 740 can be separated by boundary 745.

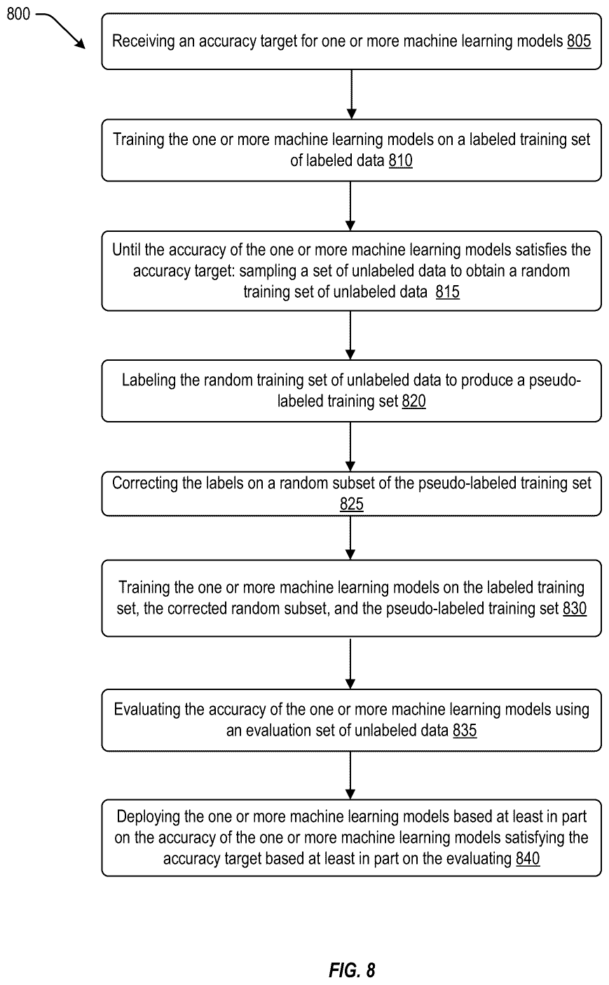

FIG. 8 is diagram of a process 800 for training a machine learning model according to at least one embodiment. This process is illustrated as a logical flow diagram, each operation of which can be implemented in hardware, computer instructions, or a combination thereof. In the context of computer instructions, the operations may represent computer-executable instructions stored on one or more computer-readable storage media that, when executed by one or more processors, perform the recited operations. Generally, computer-executable instructions include routines, programs, objects, components, data structures and the like that perform particular functions or implement particular data types. The orders in which the operations are described are not intended to be construed as a limitation, and any number of the described operations can be combined in any order and/or in parallel to implement the processes or the method.

Turning to process 800 in greater detail, at block 805, an accuracy target for the one or more machine learning models can be received. The accuracy target can be a value for an accuracy metric such as classification accuracy, logarithmic loss, confusion matrix, area under curve, F1 score, mean absolute error, mean squared error, or any other accuracy metrics. The accuracy target can be provided via console 425.

At block 810, the one or more machine learning models can be trained on a labeled training set of labeled data. The labeled training set of labeled data can be labeled training data 415 that is provided via image API(s) 410. The labeled training data can include one or more identified entities 550, at least one bounding box 555 surrounding each entity, and at least one label 560 for each entity.

At block 815, a set of unlabeled data can be sampled to obtain a random training set of unlabeled data. Any combination of blocks 815-835, can be repeated until the accuracy of the one or more machine learning models satisfies the accuracy target. The unlabeled data can be unlabeled data 565 and the unlabeled data can be sampled with or without replacement. For example, the random training set of unlabeled data can be sampled using bootstrapping techniques. The random training set of unlabeled data can be sampled randomly or using any applicable sampling techniques that result in a training set of unlabeled data that is representative of the unlabeled data.

At block 820, the random set of unlabeled data from 815 can be labeled using the one or more machine learning models to produce a pseudo-labeled training set. Pseudo labeled data can be data that was labeled by a machine learning model. The model or models labeling data at 820 can be models that were previously trained at 830. One or more additional models can be used in addition to the models that were previously trained at 830.

At block 825, the labels on a random subset of the pseudo-labeled training data set can be corrected to produce a corrected random subset of the pseudo-labeled training data. The random subset of pseudo-labeled training data can be selected using any sampling technique that can used to create a sample that represents the subset of pseudo-labeled training data. The random subset can be any proportion of the pseudo-labeled training data set (e.g., 1%-10% of the pseudo-labeled training data set).

In some embodiments, a random subsample of a particular class of data can be corrected. For example, a particular class of data (e.g., a datum having a particular entity or type of entity in an image) may be difficult for a model to classify, and the model may fail to meet accuracy targets for this class of data. A random subsample of pseudo labeled data from this class (e.g., data with model assigned labels for cars) may be selected and corrected. Such corrections can help mitigate the possibility that the model is underperforming on this class of data because the pseudo-labels for this class of data are inaccurate.

At block 830, the one or more machine learning models can be trained. The models can be trained on one or more of the labeled training data set, the corrected random subset, or the pseudo-labeled training set. The machine learning model can be a single model or multiple machine learning models that are trained using ensemble learning techniques such as stacking, boosting, or bagging. During training, the training data can be altered using test time augmentation techniques. Test time augmentation involves randomly altering a datum during training of a model so that the exact same datum is not shown to the model twice. For instance, the image can be flipped, inverted, cropped, blurred, or otherwise altered each time the image (e.g., datum) is presented to the model. The test time augmentation techniques can include vertical/horizontal flipping, blurring, random cropping, or histogram equalization (e.g., changing the contrast of the images). During training, any dataset can be randomly subsetted (e.g., produced or manipulated by retrieving a subset) for training ensemble models and parts of the ensemble models using for iterative pseudo labeling of a large unlabeled data and concurrent retraining of the models until an accuracy threshold has been exceeded.

At block 835, the accuracy of the one or more machine learning models can be evaluated using an evaluation set of unlabeled data. The one or more machine learning models can be evaluated for accuracy labeling all classes of data, for accuracy in labeling one or more specific classes of data, or for a combination thereof. If multiple accuracy targets are used, the accuracy targets can be different for each evaluated class. If the model satisfies the one or more accuracy targets, the model can be deployed at 840. If the model does not satisfy the accuracy targets, the technique can return to 820. In this way, a series of models can be iteratively trained until accuracy targets are satisfied. The accuracy target can be a threshold that is determined based at least in part on a performance of the one or more machine learning models in classifying unlabeled data.

At block 840, the one or more machine learning models can be deployed based at least in part on a determination at 835 that the one or more machine learning models satisfies the accuracy target from 805. In some embodiments, the model may need to satisfy multiple accuracy targets at 805 in order for the model to be deployed. The decision to deploy the models can be based at least in part on the evaluation at 835.

As noted above, infrastructure as a service (IaaS) is one particular type of cloud computing. IaaS can be configured to provide virtualized computing resources over a public network (e.g., the Internet). In an IaaS model, a cloud computing provider can host the infrastructure components (e.g., servers, storage devices, network nodes (e.g., hardware), deployment software, platform virtualization (e.g., a hypervisor layer), or the like). In some cases, an IaaS provider may also supply a variety of services to accompany those infrastructure components (example services include billing software, monitoring software, logging software, load balancing software, clustering software, etc.). Thus, as these services may be policy-driven, IaaS users may be able to implement policies to drive load balancing to maintain application availability and performance.

In some instances, IaaS customers may access resources and services through a wide area network (WAN), such as the Internet, and can use the cloud provider's services to install the remaining elements of an application stack. For example, the user can log in to the IaaS platform to create virtual machines (VMs), install operating systems (OSs) on each VM, deploy middleware such as databases, create storage buckets for workloads and backups, and even install enterprise software into that VM. Customers can then use the provider's services to perform various functions, including balancing network traffic, troubleshooting application issues, monitoring performance, managing disaster recovery, etc.

In most cases, a cloud computing model will require the participation of a cloud provider. The cloud provider may, but need not be, a third-party service that specializes in providing (e.g., offering, renting, selling) IaaS. An entity might also opt to deploy a private cloud, becoming its own provider of infrastructure services.

In some examples, IaaS deployment is the process of putting a new application, or a new version of an application, onto a prepared application server or the like. It may also include the process of preparing the server (e.g., installing libraries, daemons, etc.). This is often managed by the cloud provider, below the hypervisor layer (e.g., the servers, storage, network hardware, and virtualization). Thus, the customer may be responsible for handling (OS), middleware, and/or application deployment (e.g., on self-service virtual machines (e.g., that can be spun up on demand) or the like.

In some examples, IaaS provisioning may refer to acquiring computers or virtual hosts for use, and even installing needed libraries or services on them. In most cases, deployment does not include provisioning, and the provisioning may need to be performed first.

In some cases, there are two different challenges for IaaS provisioning. First, there is the initial challenge of provisioning the initial set of infrastructure before anything is running. Second, there is the challenge of evolving the existing infrastructure (e.g., adding new services, changing services, removing services, etc.) once everything has been provisioned. In some cases, these two challenges may be addressed by enabling the configuration of the infrastructure to be defined declaratively. In other words, the infrastructure (e.g., what components are needed and how they interact) can be defined by one or more configuration files. Thus, the overall topology of the infrastructure (e.g., what resources depend on which, and how they each work together) can be described declaratively. In some instances, once the topology is defined, a workflow can be generated that creates and/or manages the different components described in the configuration files.

In some examples, an infrastructure may have many interconnected elements. For example, there may be one or more virtual private clouds (VPCs) (e.g., a potentially on-demand pool of configurable and/or shared computing resources), also known as a core network. In some examples, there may also be one or more inbound/outbound traffic group rules provisioned to define how the inbound and/or outbound traffic of the network will be set up and one or more virtual machines (VMs). Other infrastructure elements may also be provisioned, such as a load balancer, a database, or the like. As more and more infrastructure elements are desired and/or added, the infrastructure may incrementally evolve.

In some instances, continuous deployment techniques may be employed to enable deployment of infrastructure code across various virtual computing environments. Additionally, the described techniques can enable infrastructure management within these environments. In some examples, service teams can write code that is desired to be deployed to one or more, but often many, different production environments (e.g., across various different geographic locations, sometimes spanning the entire world). However, in some examples, the infrastructure on which the code will be deployed must first be set up. In some instances, the provisioning can be done manually, a provisioning tool may be utilized to provision the resources, and/or deployment tools may be utilized to deploy the code once the infrastructure is provisioned.

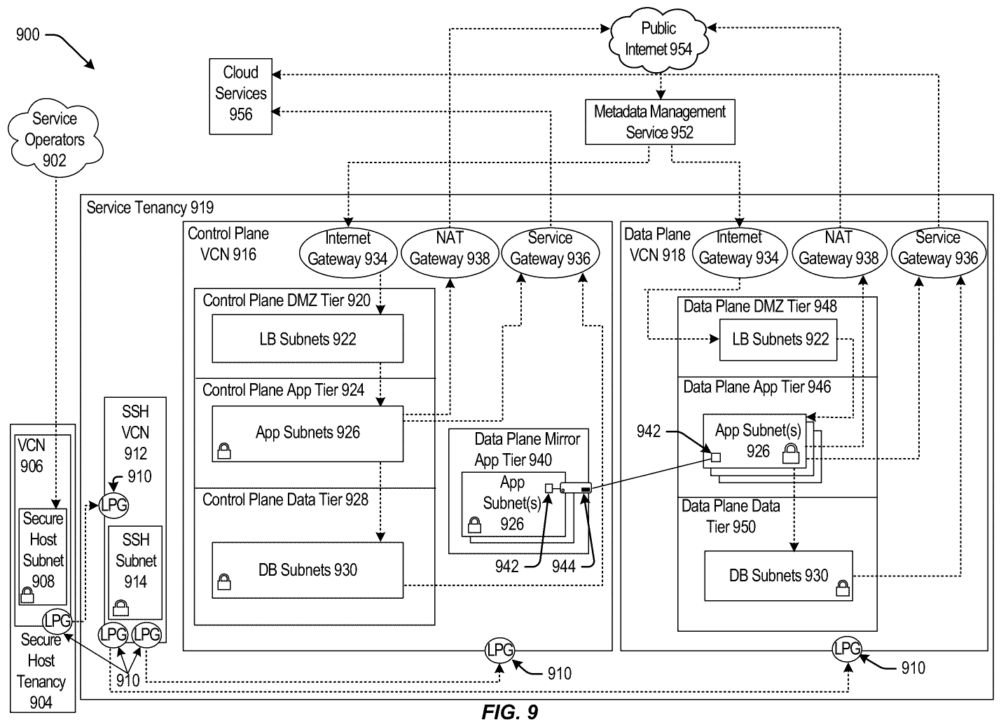

FIG. 9 is a block diagram 900 illustrating an example pattern of an IaaS architecture, according to at least one embodiment. Service operators 902 can be communicatively coupled to a secure host tenancy 904 that can include a virtual cloud network (VCN) 906 and a secure host subnet 908. In some examples, the service operators 902 may be using one or more client computing devices, which may be portable handheld devices (e.g., an iPhone®, cellular telephone, an iPad®, computing tablet, a personal digital assistant (PDA)) or wearable devices (e.g., a Google Glass® head mounted display), running software such as Microsoft Windows Mobile®, and/or a variety of mobile operating systems such as iOS, Windows Phone, Android, BlackBerry 8, Palm OS, and the like, and being Internet, e-mail, short message service (SMS), Blackberry®, or other communication protocol enabled. Alternatively, the client computing devices can be general purpose personal computers including, by way of example, personal computers and/or laptop computers running various versions of Microsoft Windows®, Apple Macintosh®, and/or Linux operating systems. The client computing devices can be workstation computers running any of a variety of commercially-available UNIX® or UNIX-like operating systems, including without limitation the variety of GNU/Linux operating systems, such as for example, Google Chrome OS. Alternatively, or in addition, client computing devices may be any other electronic device, such as a thin-client computer, an Internet-enabled gaming system (e.g., a Microsoft Xbox gaming console with or without a Kinect® gesture input device), and/or a personal messaging device, capable of communicating over a network that can access the VCN 906 and/or the Internet.

The VCN 906 can include a local peering gateway (LPG) 910 that can be communicatively coupled to a secure shell (SSH) VCN 912 via an LPG 910 contained in the SSH VCN 912. The SSH VCN 912 can include an SSH subnet 914, and the SSH VCN 912 can be communicatively coupled to a control plane VCN 916 via the LPG 910 contained in the control plane VCN 916. Also, the SSH VCN 912 can be communicatively coupled to a data plane VCN 918 via an LPG 910. The control plane VCN 916 and the data plane VCN 918 can be contained in a service tenancy 919 that can be owned and/or operated by the IaaS provider.

The control plane VCN 916 can include a control plane demilitarized zone (DMZ) tier 920 that acts as a perimeter network (e.g., portions of a corporate network between the corporate intranet and external networks). The DMZ-based servers may have restricted responsibilities and help keep breaches contained. Additionally, the DMZ tier 920 can include one or more load balancer (LB) subnet(s) 922, a control plane app tier 924 that can include app subnet(s) 926, a control plane data tier 928 that can include database (DB) subnet(s) 930 (e.g., frontend DB subnet(s) and/or backend DB subnet(s)). The LB subnet(s) 922 contained in the control plane DMZ tier 920 can be communicatively coupled to the app subnet(s) 926 contained in the control plane app tier 924 and an Internet gateway 934 that can be contained in the control plane VCN 916, and the app subnet(s) 926 can be communicatively coupled to the DB subnet(s) 930 contained in the control plane data tier 928 and a service gateway 936 and a network address translation (NAT) gateway 938. The control plane VCN 916 can include the service gateway 936 and the NAT gateway 938.

The control plane VCN 916 can include a data plane mirror app tier 940 that can include app subnet(s) 926. The app subnet(s) 926 contained in the data plane mirror app tier 940 can include a virtual network interface controller (VNIC) 942 that can execute a compute instance 944. The compute instance 944 can communicatively couple the app subnet(s) 926 of the data plane mirror app tier 940 to app subnet(s) 926 that can be contained in a data plane app tier 946.

The data plane VCN 918 can include the data plane app tier 946, a data plane DMZ tier 948, and a data plane data tier 950. The data plane DMZ tier 948 can include LB subnet(s) 922 that can be communicatively coupled to the app subnet(s) 926 of the data plane app tier 946 and the Internet gateway 934 of the data plane VCN 918. The app subnet(s) 926 can be communicatively coupled to the service gateway 936 of the data plane VCN 918 and the NAT gateway 938 of the data plane VCN 918. The data plane data tier 950 can also include the DB subnet(s) 930 that can be communicatively coupled to the app subnet(s) 926 of the data plane app tier 946.

The Internet gateway 934 of the control plane VCN 916 and of the data plane VCN 918 can be communicatively coupled to a metadata management service 952 that can be communicatively coupled to public Internet 954. Public Internet 954 can be communicatively coupled to the NAT gateway 938 of the control plane VCN 916 and of the data plane VCN 918. The service gateway 936 of the control plane VCN 916 and of the data plane VCN 918 can be communicatively couple to cloud services 956.

In some examples, the service gateway 936 of the control plane VCN 916 or of the data plane VCN 918 can make application programming interface (API) calls to cloud services 956 without going through public Internet 954. The API calls to cloud services 956 from the service gateway 936 can be one-way: the service gateway 936 can make API calls to cloud services 956, and cloud services 956 can send requested data to the service gateway 936. But, cloud services 956 may not initiate API calls to the service gateway 936.

In some examples, the secure host tenancy 904 can be directly connected to the service tenancy 919, which may be otherwise isolated. The secure host subnet 908 can communicate with the SSH subnet 914 through an LPG 910 that may enable two-way communication over an otherwise isolated system. Connecting the secure host subnet 908 to the SSH subnet 914 may give the secure host subnet 908 access to other entities within the service tenancy 919.

The control plane VCN 916 may allow users of the service tenancy 919 to set up or otherwise provision desired resources. Desired resources provisioned in the control plane VCN 916 may be deployed or otherwise used in the data plane VCN 918. In some examples, the control plane VCN 916 can be isolated from the data plane VCN 918, and the data plane mirror app tier 940 of the control plane VCN 916 can communicate with the data plane app tier 946 of the data plane VCN 918 via VNICs 942 that can be contained in the data plane mirror app tier 940 and the data plane app tier 946.

In some examples, users of the system, or customers, can make requests, for example create, read, update, or delete (CRUD) operations, through public Internet 954 that can communicate the requests to the metadata management service 952. The metadata management service 952 can communicate the request to the control plane VCN 916 through the Internet gateway 934. The request can be received by the LB subnet(s) 922 contained in the control plane DMZ tier 920. The LB subnet(s) 922 may determine that the request is valid, and in response to this determination, the LB subnet(s) 922 can transmit the request to app subnet(s) 926 contained in the control plane app tier 924. If the request is validated and requires a call to public Internet 954, the call to public Internet 954 may be transmitted to the NAT gateway 938 that can make the call to public Internet 954. Metadata that may be desired to be stored by the request can be stored in the DB subnet(s) 930.

In some examples, the data plane mirror app tier 940 can facilitate direct communication between the control plane VCN 916 and the data plane VCN 918. For example, changes, updates, or other suitable modifications to configuration may be desired to be applied to the resources contained in the data plane VCN 918. Via a VNIC 942, the control plane VCN 916 can directly communicate with, and can thereby execute the changes, updates, or other suitable modifications to configuration to, resources contained in the data plane VCN 918.

In some embodiments, the control plane VCN 916 and the data plane VCN 918 can be contained in the service tenancy 919. In this case, the user, or the customer, of the system may not own or operate either the control plane VCN 916 or the data plane VCN 918. Instead, the IaaS provider may own or operate the control plane VCN 916 and the data plane VCN 918, both of which may be contained in the service tenancy 919. This embodiment can enable isolation of networks that may prevent users or customers from interacting with other users', or other customers', resources. Also, this embodiment may allow users or customers of the system to store databases privately without needing to rely on public Internet 954, which may not have a desired level of threat prevention, for storage.

In other embodiments, the LB subnet(s) 922 contained in the control plane VCN 916 can be configured to receive a signal from the service gateway 936. In this embodiment, the control plane VCN 916 and the data plane VCN 918 may be configured to be called by a customer of the IaaS provider without calling public Internet 954. Customers of the IaaS provider may desire this embodiment since database(s) that the customers use may be controlled by the IaaS provider and may be stored on the service tenancy 919, which may be isolated from public Internet 954.

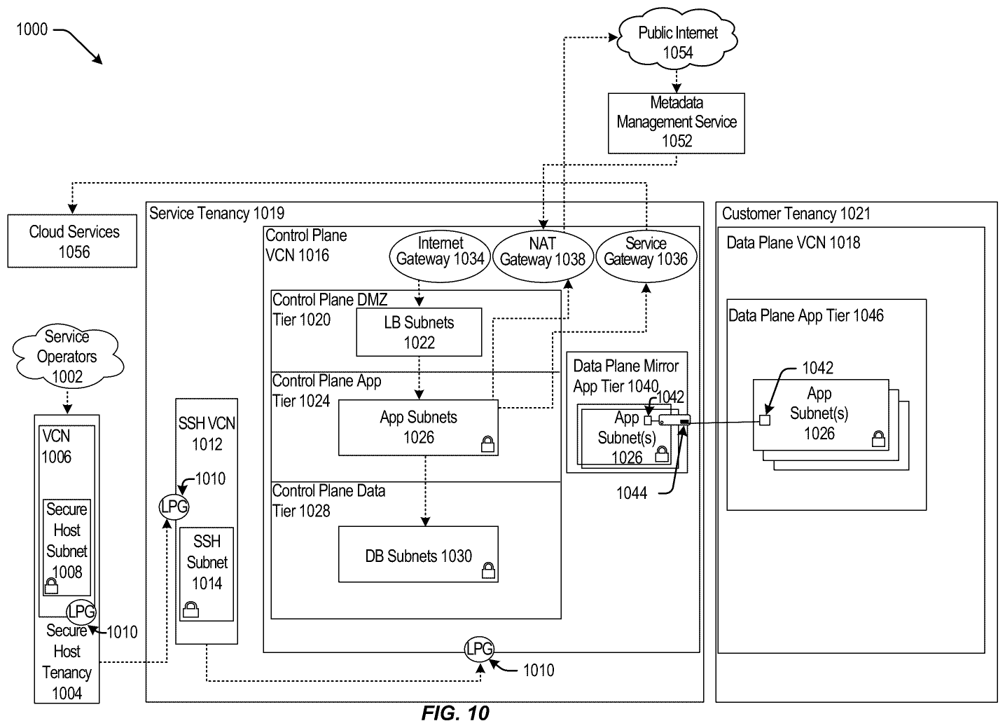

FIG. 10 is a block diagram 1000 illustrating another example pattern of an IaaS architecture, according to at least one embodiment. Service operators 1002 (e.g., service operators 902 of FIG. 9) can be communicatively coupled to a secure host tenancy 1004 (e.g., the secure host tenancy 904 of FIG. 9) that can include a virtual cloud network (VCN) 1006 (e.g., the VCN 906 of FIG. 9) and a secure host subnet 1008 (e.g., the secure host subnet 908 of FIG. 9). The VCN 1006 can include a local peering gateway (LPG) 1010 (e.g., the LPG 910 of FIG. 9) that can be communicatively coupled to a secure shell (SSH) VCN 1012 (e.g., the SSH VCN 912 of FIG. 9) via an LPG 910 contained in the SSH VCN 1012. The SSH VCN 1012 can include an SSH subnet 1014 (e.g., the SSH subnet 914 of FIG. 9), and the SSH VCN 1012 can be communicatively coupled to a control plane VCN 1016 (e.g., the control plane VCN 916 of FIG. 9) via an LPG 1010 contained in the control plane VCN 1016. The control plane VCN 1016 can be contained in a service tenancy 1019 (e.g., the service tenancy 919 of FIG. 9), and the data plane VCN 1018 (e.g., the data plane VCN 918 of FIG. 9) can be contained in a customer tenancy 1021 that may be owned or operated by users, or customers, of the system.

The control plane VCN 1016 can include a control plane DMZ tier 1020 (e.g., the control plane DMZ tier 920 of FIG. 9) that can include LB subnet(s) 1022 (e.g., LB subnet(s) 922 of FIG. 9), a control plane app tier 1024 (e.g., the control plane app tier 924 of FIG. 9) that can include app subnet(s) 1026 (e.g., app subnet(s) 926 of FIG. 9), a control plane data tier 1028 (e.g., the control plane data tier 928 of FIG. 9) that can include database (DB) subnet(s) 1030 (e.g., similar to DB subnet(s) 930 of FIG. 9). The LB subnet(s) 1022 contained in the control plane DMZ tier 1020 can be communicatively coupled to the app subnet(s) 1026 contained in the control plane app tier 1024 and an Internet gateway 1034 (e.g., the Internet gateway 934 of FIG. 9) that can be contained in the control plane VCN 1016, and the app subnet(s) 1026 can be communicatively coupled to the DB subnet(s) 1030 contained in the control plane data tier 1028 and a service gateway 1036 (e.g., the service gateway 936 of FIG. 9) and a network address translation (NAT) gateway 1038 (e.g., the NAT gateway 938 of FIG. 9). The control plane VCN 1016 can include the service gateway 1036 and the NAT gateway 1038.

The control plane VCN 1016 can include a data plane mirror app tier 1040 (e.g., the data plane mirror app tier 940 of FIG. 9) that can include app subnet(s) 1026. The app subnet(s) 1026 contained in the data plane mirror app tier 1040 can include a virtual network interface controller (VNIC) 1042 (e.g., the VNIC of 942) that can execute a compute instance 1044 (e.g., similar to the compute instance 944 of FIG. 9). The compute instance 1044 can facilitate communication between the app subnet(s) 1026 of the data plane mirror app tier 1040 and the app subnet(s) 1026 that can be contained in a data plane app tier 1046 (e.g., the data plane app tier 946 of FIG. 9) via the VNIC 1042 contained in the data plane mirror app tier 1040 and the VNIC 1042 contained in the data plane app tier 1046.

The Internet gateway 1034 contained in the control plane VCN 1016 can be communicatively coupled to a metadata management service 1052 (e.g., the metadata management service 952 of FIG. 9) that can be communicatively coupled to public Internet 1054 (e.g., public Internet 954 of FIG. 9). Public Internet 1054 can be communicatively coupled to the NAT gateway 1038 contained in the control plane VCN 1016. The service gateway 1036 contained in the control plane VCN 1016 can be communicatively couple to cloud services 1056 (e.g., cloud services 956 of FIG. 9).

In some examples, the data plane VCN 1018 can be contained in the customer tenancy 1021. In this case, the IaaS provider may provide the control plane VCN 1016 for each customer, and the IaaS provider may, for each customer, set up a unique compute instance 1044 that is contained in the service tenancy 1019. Each compute instance 1044 may allow communication between the control plane VCN 1016, contained in the service tenancy 1019, and the data plane VCN 1018 that is contained in the customer tenancy 1021. The compute instance 1044 may allow resources, that are provisioned in the control plane VCN 1016 that is contained in the service tenancy 1019, to be deployed or otherwise used in the data plane VCN 1018 that is contained in the customer tenancy 1021.

In other examples, the customer of the IaaS provider may have databases that live in the customer tenancy 1021. In this example, the control plane VCN 1016 can include the data plane mirror app tier 1040 that can include app subnet(s) 1026. The data plane mirror app tier 1040 can reside in the data plane VCN 1018, but the data plane mirror app tier 1040 may not live in the data plane VCN 1018. That is, the data plane mirror app tier 1040 may have access to the customer tenancy 1021, but the data plane mirror app tier 1040 may not exist in the data plane VCN 1018 or be owned or operated by the customer of the IaaS provider. The data plane mirror app tier 1040 may be configured to make calls to the data plane VCN 1018 but may not be configured to make calls to any entity contained in the control plane VCN 1016. The customer may desire to deploy or otherwise use resources in the data plane VCN 1018 that are provisioned in the control plane VCN 1016, and the data plane mirror app tier 1040 can facilitate the desired deployment, or other usage of resources, of the customer.

In some embodiments, the customer of the IaaS provider can apply filters to the data plane VCN 1018. In this embodiment, the customer can determine what the data plane VCN 1018 can access, and the customer may restrict access to public Internet 1054 from the data plane VCN 1018. The IaaS provider may not be able to apply filters or otherwise control access of the data plane VCN 1018 to any outside networks or databases. Applying filters and controls by the customer onto the data plane VCN 1018, contained in the customer tenancy 1021, can help isolate the data plane VCN 1018 from other customers and from public Internet 1054.

In some embodiments, cloud services 1056 can be called by the service gateway 1036 to access services that may not exist on public Internet 1054, on the control plane VCN 1016, or on the data plane VCN 1018. The connection between cloud services 1056 and the control plane VCN 1016 or the data plane VCN 1018 may not be live or continuous. Cloud services 1056 may exist on a different network owned or operated by the IaaS provider. Cloud services 1056 may be configured to receive calls from the service gateway 1036 and may be configured to not receive calls from public Internet 1054. Some cloud services 1056 may be isolated from other cloud services 1056, and the control plane VCN 1016 may be isolated from cloud services 1056 that may not be in the same region as the control plane VCN 1016. For example, the control plane VCN 1016 may be located in “Region 1,” and cloud service “Deployment 9,” may be located in Region 1 and in “Region 2.” If a call to Deployment 9 is made by the service gateway 1036 contained in the control plane VCN 1016 located in Region 1, the call may be transmitted to Deployment 9 in Region 1. In this example, the control plane VCN 1016, or Deployment 9 in Region 1, may not be communicatively coupled to, or otherwise in communication with, Deployment 9 in Region 2.

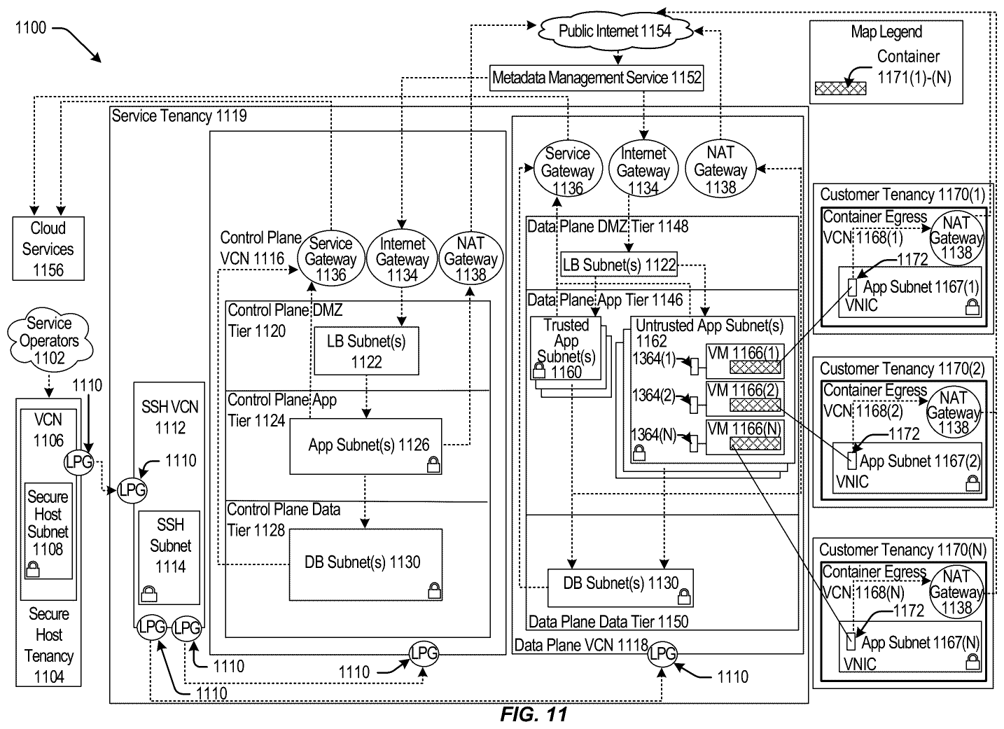

FIG. 11 is a block diagram 1100 illustrating another example pattern of an IaaS architecture, according to at least one embodiment. Service operators 1102 (e.g., service operators 902 of FIG. 9) can be communicatively coupled to a secure host tenancy 1104 (e.g., the secure host tenancy 904 of FIG. 9) that can include a virtual cloud network (VCN) 1106 (e.g., the VCN 906 of FIG. 9) and a secure host subnet 1108 (e.g., the secure host subnet 908 of FIG. 9). The VCN 1106 can include an LPG 1110 (e.g., the LPG 910 of FIG. 9) that can be communicatively coupled to an SSH VCN 1112 (e.g., the SSH VCN 912 of FIG. 9) via an LPG 1110 contained in the SSH VCN 1112. The SSH VCN 1112 can include an SSH subnet 1114 (e.g., the SSH subnet 914 of FIG. 9), and the SSH VCN 1112 can be communicatively coupled to a control plane VCN 1116 (e.g., the control plane VCN 916 of FIG. 9) via an LPG 1110 contained in the control plane VCN 1116 and to a data plane VCN 1118 (e.g., the data plane 918 of FIG. 9) via an LPG 1110 contained in the data plane VCN 1118. The control plane VCN 1116 and the data plane VCN 1118 can be contained in a service tenancy 1119 (e.g., the service tenancy 919 of FIG. 9).

The control plane VCN 1116 can include a control plane DMZ tier 1120 (e.g., the control plane DMZ tier 920 of FIG. 9) that can include load balancer (LB) subnet(s) 1122 (e.g., LB subnet(s) 922 of FIG. 9), a control plane app tier 1124 (e.g., the control plane app tier 924 of FIG. 9) that can include app subnet(s) 1126 (e.g., similar to app subnet(s) 926 of FIG. 9), a control plane data tier 1128 (e.g., the control plane data tier 928 of FIG. 9) that can include DB subnet(s) 1130. The LB subnet(s) 1122 contained in the control plane DMZ tier 1120 can be communicatively coupled to the app subnet(s) 1126 contained in the control plane app tier 1124 and to an Internet gateway 1134 (e.g., the Internet gateway 934 of FIG. 9) that can be contained in the control plane VCN 1116, and the app subnet(s) 1126 can be communicatively coupled to the DB subnet(s) 1130 contained in the control plane data tier 1128 and to a service gateway 1136 (e.g., the service gateway of FIG. 9) and a network address translation (NAT) gateway 1138 (e.g., the NAT gateway 938 of FIG. 9). The control plane VCN 1116 can include the service gateway 1136 and the NAT gateway 1138.

The data plane VCN 1118 can include a data plane app tier 1146 (e.g., the data plane app tier 946 of FIG. 9), a data plane DMZ tier 1148 (e.g., the data plane DMZ tier 948 of FIG. 9), and a data plane data tier 1150 (e.g., the data plane data tier 950 of FIG. 9). The data plane DMZ tier 1148 can include LB subnet(s) 1122 that can be communicatively coupled to trusted app subnet(s) 1160 and untrusted app subnet(s) 1162 of the data plane app tier 1146 and the Internet gateway 1134 contained in the data plane VCN 1118. The trusted app subnet(s) 1160 can be communicatively coupled to the service gateway 1136 contained in the data plane VCN 1118, the NAT gateway 1138 contained in the data plane VCN 1118, and DB subnet(s) 1130 contained in the data plane data tier 1150. The untrusted app subnet(s) 1162 can be communicatively coupled to the service gateway 1136 contained in the data plane VCN 1118 and DB subnet(s) 1130 contained in the data plane data tier 1150. The data plane data tier 1150 can include DB subnet(s) 1130 that can be communicatively coupled to the service gateway 1136 contained in the data plane VCN 1118.

The untrusted app subnet(s) 1162 can include one or more primary VNICs 1164(1)-(N) that can be communicatively coupled to tenant virtual machines (VMs) 1166(1)-(N). Each tenant VM 1166(1)-(N) can be communicatively coupled to a respective app subnet 1167(1)-(N) that can be contained in respective container egress VCNs 1168(1)-(N) that can be contained in respective customer tenancies 1170(1)-(N). Respective secondary VNICs 1172(1)-(N) can facilitate communication between the untrusted app subnet(s) 1162 contained in the data plane VCN 1118 and the app subnet contained in the container egress VCNs 1168(1)-(N). Each container egress VCNs 1168(1)-(N) can include a NAT gateway 1138 that can be communicatively coupled to public Internet 1154 (e.g., public Internet 954 of FIG. 9).

The Internet gateway 1134 contained in the control plane VCN 1116 and contained in the data plane VCN 1118 can be communicatively coupled to a metadata management service 1152 (e.g., the metadata management system 952 of FIG. 9) that can be communicatively coupled to public Internet 1154. Public Internet 1154 can be communicatively coupled to the NAT gateway 1138 contained in the control plane VCN 1116 and contained in the data plane VCN 1118. The service gateway 1136 contained in the control plane VCN 1116 and contained in the data plane VCN 1118 can be communicatively couple to cloud services 1156.

In some embodiments, the data plane VCN 1118 can be integrated with customer tenancies 1170. This integration can be useful or desirable for customers of the IaaS provider in some cases such as a case that may desire support when executing code. The customer may provide code to run that may be destructive, may communicate with other customer resources, or may otherwise cause undesirable effects. In response to this, the IaaS provider may determine whether to run code given to the IaaS provider by the customer.

In some examples, the customer of the IaaS provider may grant temporary network access to the IaaS provider and request a function to be attached to the data plane app tier 1146. Code to run the function may be executed in the VMs 1166(1)-(N), and the code may not be configured to run anywhere else on the data plane VCN 1118. Each VM 1166(1)-(N) may be connected to one customer tenancy 1170. Respective containers 1171(1)-(N) contained in the VMs 1166(1)-(N) may be configured to run the code. In this case, there can be a dual isolation (e.g., the containers 1171(1)-(N) running code, where the containers 1171(1)-(N) may be contained in at least the VM 1166(1)-(N) that are contained in the untrusted app subnet(s) 1162), which may help prevent incorrect or otherwise undesirable code from damaging the network of the IaaS provider or from damaging a network of a different customer. The containers 1171(1)-(N) may be communicatively coupled to the customer tenancy 1170 and may be configured to transmit or receive data from the customer tenancy 1170. The containers 1171(1)-(N) may not be configured to transmit or receive data from any other entity in the data plane VCN 1118. Upon completion of running the code, the IaaS provider may kill or otherwise dispose of the containers 1171(1)-(N).

In some embodiments, the trusted app subnet(s) 1160 may run code that may be owned or operated by the IaaS provider. In this embodiment, the trusted app subnet(s) 1160 may be communicatively coupled to the DB subnet(s) 1130 and be configured to execute CRUD operations in the DB subnet(s) 1130. The untrusted app subnet(s) 1162 may be communicatively coupled to the DB subnet(s) 1130, but in this embodiment, the untrusted app subnet(s) may be configured to execute read operations in the DB subnet(s) 1130. The containers 1171(1)-(N) that can be contained in the VM 1166(1)-(N) of each customer and that may run code from the customer may not be communicatively coupled with the DB subnet(s) 1130.

In other embodiments, the control plane VCN 1116 and the data plane VCN 1118 may not be directly communicatively coupled. In this embodiment, there may be no direct communication between the control plane VCN 1116 and the data plane VCN 1118. However, communication can occur indirectly through at least one method. An LPG 1110 may be established by the IaaS provider that can facilitate communication between the control plane VCN 1116 and the data plane VCN 1118. In another example, the control plane VCN 1116 or the data plane VCN 1118 can make a call to cloud services 1156 via the service gateway 1136. For example, a call to cloud services 1156 from the control plane VCN 1116 can include a request for a service that can communicate with the data plane VCN 1118.

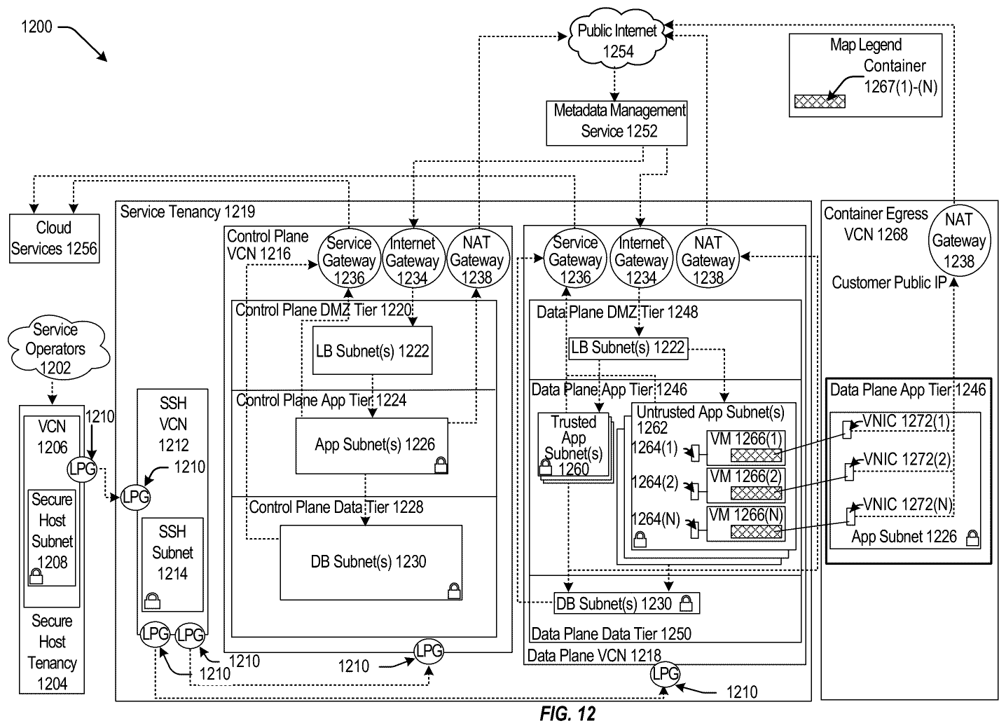

FIG. 12 is a block diagram 1200 illustrating another example pattern of an IaaS architecture, according to at least one embodiment. Service operators 1202 (e.g., service operators 902 of FIG. 9) can be communicatively coupled to a secure host tenancy 1204 (e.g., the secure host tenancy 904 of FIG. 9) that can include a virtual cloud network (VCN) 1206 (e.g., the VCN 906 of FIG. 9) and a secure host subnet 1208 (e.g., the secure host subnet 908 of FIG. 9). The VCN 1206 can include an LPG 1210 (e.g., the LPG 910 of FIG. 9) that can be communicatively coupled to an SSH VCN 1212 (e.g., the SSH VCN 912 of FIG. 9) via an LPG 1210 contained in the SSH VCN 1212. The SSH VCN 1212 can include an SSH subnet 1214 (e.g., the SSH subnet 914 of FIG. 9), and the SSH VCN 1212 can be communicatively coupled to a control plane VCN 1216 (e.g., the control plane VCN 916 of FIG. 9) via an LPG 1210 contained in the control plane VCN 1216 and to a data plane VCN 1218 (e.g., the data plane 918 of FIG. 9) via an LPG 1210 contained in the data plane VCN 1218. The control plane VCN 1216 and the data plane VCN 1218 can be contained in a service tenancy 1219 (e.g., the service tenancy 919 of FIG. 9).

The control plane VCN 1216 can include a control plane DMZ tier 1220 (e.g., the control plane DMZ tier 920 of FIG. 9) that can include LB subnet(s) 1222 (e.g., LB subnet(s) 922 of FIG. 9), a control plane app tier 1224 (e.g., the control plane app tier 924 of FIG. 9) that can include app subnet(s) 1226 (e.g., app subnet(s) 926 of FIG. 9), a control plane data tier 1228 (e.g., the control plane data tier 928 of FIG. 9) that can include DB subnet(s) 1230 (e.g., DB subnet(s) 1130 of FIG. 11). The LB subnet(s) 1222 contained in the control plane DMZ tier 1220 can be communicatively coupled to the app subnet(s) 1226 contained in the control plane app tier 1224 and to an Internet gateway 1234 (e.g., the Internet gateway 934 of FIG. 9) that can be contained in the control plane VCN 1216, and the app subnet(s) 1226 can be communicatively coupled to the DB subnet(s) 1230 contained in the control plane data tier 1228 and to a service gateway 1236 (e.g., the service gateway of FIG. 9) and a network address translation (NAT) gateway 1238 (e.g., the NAT gateway 938 of FIG. 9). The control plane VCN 1216 can include the service gateway 1236 and the NAT gateway 1238.

The data plane VCN 1218 can include a data plane app tier 1246 (e.g., the data plane app tier 946 of FIG. 9), a data plane DMZ tier 1248 (e.g., the data plane DMZ tier 948 of FIG. 9), and a data plane data tier 1250 (e.g., the data plane data tier 950 of FIG. 9). The data plane DMZ tier 1248 can include LB subnet(s) 1222 that can be communicatively coupled to trusted app subnet(s) 1260 (e.g., trusted app subnet(s) 1160 of FIG. 11) and untrusted app subnet(s) 1262 (e.g., untrusted app subnet(s) 1162 of FIG. 11) of the data plane app tier 1246 and the Internet gateway 1234 contained in the data plane VCN 1218. The trusted app subnet(s) 1260 can be communicatively coupled to the service gateway 1236 contained in the data plane VCN 1218, the NAT gateway 1238 contained in the data plane VCN 1218, and DB subnet(s) 1230 contained in the data plane data tier 1250. The untrusted app subnet(s) 1262 can be communicatively coupled to the service gateway 1236 contained in the data plane VCN 1218 and DB subnet(s) 1230 contained in the data plane data tier 1250. The data plane data tier 1250 can include DB subnet(s) 1230 that can be communicatively coupled to the service gateway 1236 contained in the data plane VCN 1218.

The untrusted app subnet(s) 1262 can include primary VNICs 1264(1)-(N) that can be communicatively coupled to tenant virtual machines (VMs) 1266(1)-(N) residing within the untrusted app subnet(s) 1262. Each tenant VM 1266(1)-(N) can run code in a respective container 1267(1)-(N), and be communicatively coupled to an app subnet 1226 that can be contained in a data plane app tier 1246 that can be contained in a container egress VCN 1268. Respective secondary VNICs 1272(1)-(N) can facilitate communication between the untrusted app subnet(s) 1262 contained in the data plane VCN 1218 and the app subnet contained in the container egress VCN 1268. The container egress VCN can include a NAT gateway 1238 that can be communicatively coupled to public Internet 1254 (e.g., public Internet 954 of FIG. 9).

The Internet gateway 1234 contained in the control plane VCN 1216 and contained in the data plane VCN 1218 can be communicatively coupled to a metadata management service 1252 (e.g., the metadata management system 952 of FIG. 9) that can be communicatively coupled to public Internet 1254. Public Internet 1254 can be communicatively coupled to the NAT gateway 1238 contained in the control plane VCN 1216 and contained in the data plane

VCN 1218. The service gateway 1236 contained in the control plane VCN 1216 and contained in the data plane VCN 1218 can be communicatively couple to cloud services 1256.

In some examples, the pattern illustrated by the architecture of block diagram 1200 of FIG. 12 may be considered an exception to the pattern illustrated by the architecture of block diagram 1100 of FIG. 11 and may be desirable for a customer of the IaaS provider if the IaaS provider cannot directly communicate with the customer (e.g., a disconnected region). The respective containers 1267(1)-(N) that are contained in the VMs 1266(1)-(N) for each customer can be accessed in real-time by the customer. The containers 1267(1)-(N) may be configured to make calls to respective secondary VNICs 1272(1)-(N) contained in app subnet(s) 1226 of the data plane app tier 1246 that can be contained in the container egress VCN 1268. The secondary

VNICs 1272(1)-(N) can transmit the calls to the NAT gateway 1238 that may transmit the calls to public Internet 1254. In this example, the containers 1267(1)-(N) that can be accessed in real-time by the customer can be isolated from the control plane VCN 1216 and can be isolated from other entities contained in the data plane VCN 1218. The containers 1267(1)-(N) may also be isolated from resources from other customers.

In other examples, the customer can use the containers 1267(1)-(N) to call cloud services 1256. In this example, the customer may run code in the containers 1267(1)-(N) that requests a service from cloud services 1256. The containers 1267(1)-(N) can transmit this request to the secondary VNICs 1272(1)-(N) that can transmit the request to the NAT gateway that can transmit the request to public Internet 1254. Public Internet 1254 can transmit the request to LB subnet(s) 1222 contained in the control plane VCN 1216 via the Internet gateway 1234. In response to determining the request is valid, the LB subnet(s) can transmit the request to app subnet(s) 1226 that can transmit the request to cloud services 1256 via the service gateway 1236.

It should be appreciated that IaaS architectures 900, 1000, 1100, 1200 depicted in the figures may have other components than those depicted. Further, the embodiments shown in the figures are only some examples of a cloud infrastructure system that may incorporate an embodiment of the disclosure. In some other embodiments, the IaaS systems may have more or fewer components than shown in the figures, may combine two or more components, or may have a different configuration or arrangement of components.

In certain embodiments, the IaaS systems described herein may include a suite of applications, middleware, and database service offerings that are delivered to a customer in a self-service, subscription-based, elastically scalable, reliable, highly available, and secure manner. An example of such an IaaS system is the Oracle Cloud Infrastructure (OCI) provided by the present assignee.

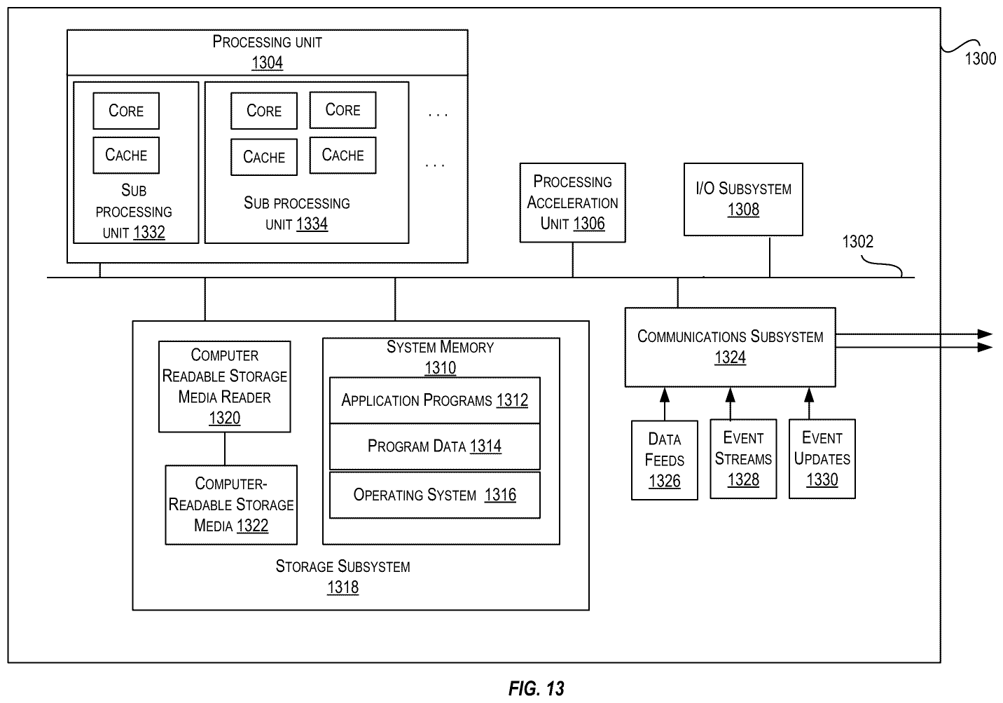

FIG. 13 illustrates an example computer system 1300, in which various embodiments may be implemented. The system 1300 may be used to implement any of the computer systems described above. As shown in the figure, computer system 1300 includes a processing unit 1304 that communicates with a number of peripheral subsystems via a bus subsystem 1302. These peripheral subsystems may include a processing acceleration unit 1306, an I/O subsystem 1308, a storage subsystem 1318 and a communications subsystem 1324. Storage subsystem 1318 includes tangible computer-readable storage media 1322 and a system memory 1310.

Bus subsystem 1302 provides a mechanism for letting the various components and subsystems of computer system 1300 communicate with each other as intended. Although bus subsystem 1302 is shown schematically as a single bus, alternative embodiments of the bus subsystem may utilize multiple buses. Bus subsystem 1302 may be any of several types of bus structures including a memory bus or memory controller, a peripheral bus, and a local bus using any of a variety of bus architectures. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which can be implemented as a Mezzanine bus manufactured to the IEEE P1386.1 standard.

Processing unit 1304, which can be implemented as one or more integrated circuits (e.g., a conventional microprocessor or microcontroller), controls the operation of computer system 1300. One or more processors may be included in processing unit 1304. These processors may include single core or multicore processors. In certain embodiments, processing unit 1304 may be implemented as one or more independent processing units 1332 and/or 1334 with single or multicore processors included in each processing unit. In other embodiments, processing unit 1304 may also be implemented as a quad-core processing unit formed by integrating two dual-core processors into a single chip.

In various embodiments, processing unit 1304 can execute a variety of programs in response to program code and can maintain multiple concurrently executing programs or processes. At any given time, some or all of the program code to be executed can be resident in processor(s) 1304 and/or in storage subsystem 1318. Through suitable programming, processor(s) 1304 can provide various functionalities described above. Computer system 1300 may additionally include a processing acceleration unit 1306, which can include a digital signal processor (DSP), a special-purpose processor, and/or the like.

I/O subsystem 1308 may include user interface input devices and user interface output devices. User interface input devices may include a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may include, for example, motion sensing and/or gesture recognition devices such as the Microsoft Kinect® motion sensor that enables users to control and interact with an input device, such as the Microsoft Xbox® 360 game controller, through a natural user interface using gestures and spoken commands. User interface input devices may also include eye gesture recognition devices such as the Google Glass® blink detector that detects eye activity (e.g., ‘blinking’ while taking pictures and/or making a menu selection) from users and transforms the eye gestures as input into an input device (e.g., Google Glass®). Additionally, user interface input devices may include voice recognition sensing devices that enable users to interact with voice recognition systems (e.g., Siri® navigator), through voice commands.

User interface input devices may also include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, barcode reader 3D scanners, 3D printers, laser rangefinders, and eye gaze tracking devices. Additionally, user interface input devices may include, for example, medical imaging input devices such as computed tomography, magnetic resonance imaging, position emission tomography, medical ultrasonography devices. User interface input devices may also include, for example, audio input devices such as MIDI keyboards, digital musical instruments and the like.

User interface output devices may include a display subsystem, indicator lights, or non-visual displays such as audio output devices, etc. The display subsystem may be a cathode ray tube (CRT), a flat-panel device, such as that using a liquid crystal display (LCD) or plasma display, a projection device, a touch screen, and the like. In general, use of the term “output device” is intended to include all possible types of devices and mechanisms for outputting information from computer system 1300 to a user or other computer. For example, user interface output devices may include, without limitation, a variety of display devices that visually convey text, graphics and audio/video information such as monitors, printers, speakers, headphones, automotive navigation systems, plotters, voice output devices, and modems.

Computer system 1300 may comprise a storage subsystem 1318 that provides a tangible non-transitory computer-readable storage medium for storing software and data constructs that provide the functionality of the embodiments described in this disclosure. The software can include programs, code modules, instructions, scripts, etc., that when executed by one or more cores or processors of processing unit 1304 provide the functionality described above. Storage subsystem 1318 may also provide a repository for storing data used in accordance with the present disclosure.

As depicted in the example in FIG. 13, storage subsystem 1318 can include various components including a system memory 1310, computer-readable storage media 1322, and a computer readable storage media reader 1320. System memory 1310 may store program instructions that are loadable and executable by processing unit 1304. System memory 1310 may also store data that is used during the execution of the instructions and/or data that is generated during the execution of the program instructions. Various different kinds of programs may be loaded into system memory 1310 including but not limited to client applications, Web browsers, mid-tier applications, relational database management systems (RDBMS), virtual machines, containers, etc.

System memory 1310 may also store an operating system 1316. Examples of operating system 1316 may include various versions of Microsoft Windows®, Apple Macintosh®, and/or Linux operating systems, a variety of commercially-available UNIX® or UNIX-like operating systems (including without limitation the variety of GNU/Linux operating systems, the Google Chrome® OS, and the like) and/or mobile operating systems such as iOS, Windows® Phone, Android® OS, BlackBerry® OS, and Palm® OS operating systems. In certain implementations where computer system 1300 executes one or more virtual machines, the virtual machines along with their guest operating systems (GOSs) may be loaded into system memory 1310 and executed by one or more processors or cores of processing unit 1304.

System memory 1310 can come in different configurations depending upon the type of computer system 1300. For example, system memory 1310 may be volatile memory (such as random access memory (RAM)) and/or non-volatile memory (such as read-only memory (ROM), flash memory, etc.) Different types of RAM configurations may be provided including a static random access memory (SRAM), a dynamic random access memory (DRAM), and others. In some implementations, system memory 1310 may include a basic input/output system (BIOS) containing basic routines that help to transfer information between elements within computer system 1300, such as during start-up.

Computer-readable storage media 1322 may represent remote, local, fixed, and/or removable storage devices plus storage media for temporarily and/or more permanently containing, storing, computer-readable information for use by computer system 1300 including instructions executable by processing unit 1304 of computer system 1300.

Computer-readable storage media 1322 can include any appropriate media known or used in the art, including storage media and communication media, such as but not limited to, volatile and non-volatile, removable and non-removable media implemented in any method or technology for storage and/or transmission of information. This can include tangible computer-readable storage media such as RAM, ROM, electronically erasable programmable ROM (EEPROM), flash memory or other memory technology, CD-ROM, digital versatile disk (DVD), or other optical storage, magnetic cassettes, magnetic tape, magnetic disk storage or other magnetic storage devices, or other tangible computer readable media.

By way of example, computer-readable storage media 1322 may include a hard disk drive that reads from or writes to non-removable, nonvolatile magnetic media, a magnetic disk drive that reads from or writes to a removable, nonvolatile magnetic disk, and an optical disk drive that reads from or writes to a removable, nonvolatile optical disk such as a CD ROM, DVD, and Blu-Ray® disk, or other optical media. Computer-readable storage media 1322 may include, but is not limited to, Zip® drives, flash memory cards, universal serial bus (USB) flash drives, secure digital (SD) cards, DVD disks, digital video tape, and the like. Computer-readable storage media 1322 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, DRAM-based SSDs, magnetoresistive RAM (MRAM) SSDs, and hybrid SSDs that use a combination of DRAM and flash memory based SSDs. The disk drives and their associated computer-readable media may provide non-volatile storage of computer-readable instructions, data structures, program modules, and other data for computer system 1300.

Machine-readable instructions executable by one or more processors or cores of processing unit 1304 may be stored on a non-transitory computer-readable storage medium. A non-transitory computer-readable storage medium can include physically tangible memory or storage devices that include volatile memory storage devices and/or non-volatile storage devices. Examples of non-transitory computer-readable storage medium include magnetic storage media (e.g., disk or tapes), optical storage media (e.g., DVDs, CDs), various types of RAM, ROM, or flash memory, hard drives, floppy drives, detachable memory drives (e.g., USB drives), or other type of storage device.

Communications subsystem 1324 provides an interface to other computer systems and networks. Communications subsystem 1324 serves as an interface for receiving data from and transmitting data to other systems from computer system 1300. For example, communications subsystem 1324 may enable computer system 1300 to connect to one or more devices via the Internet. In some embodiments communications subsystem 1324 can include radio frequency (RF) transceiver components for accessing wireless voice and/or data networks (e.g., using cellular telephone technology, advanced data network technology, such as 3G, 4G or EDGE (enhanced data rates for global evolution), WiFi (IEEE 802.11 family standards, or other mobile communication technologies, or any combination thereof), global positioning system (GPS) receiver components, and/or other components. In some embodiments communications subsystem 1324 can provide wired network connectivity (e.g., Ethernet) in addition to or instead of a wireless interface.

In some embodiments, communications subsystem 1324 may also receive input communication in the form of structured and/or unstructured data feeds 1326, event streams 1328, event updates 1330, and the like on behalf of one or more users who may use computer system 1300.

By way of example, communications subsystem 1324 may be configured to receive data feeds 1326 in real-time from users of social networks and/or other communication services such as Twitter® feeds, Facebook® updates, web feeds such as Rich Site Summary (RSS) feeds, and/or real-time updates from one or more third party information sources.

Additionally, communications subsystem 1324 may also be configured to receive data in the form of continuous data streams, which may include event streams 1328 of real-time events and/or event updates 1330, that may be continuous or unbounded in nature with no explicit end. Examples of applications that generate continuous data may include, for example, sensor data applications, financial tickers, network performance measuring tools (e.g., network monitoring and traffic management applications), clickstream analysis tools, automobile traffic monitoring, and the like.

Communications subsystem 1324 may also be configured to output the structured and/or unstructured data feeds 1326, event streams 1328, event updates 1330, and the like to one or more databases that may be in communication with one or more streaming data source computers coupled to computer system 1300.

Computer system 1300 can be one of various types, including a handheld portable device (e.g., an iPhone® cellular phone, an iPad® computing tablet, a PDA), a wearable device (e.g., a Google Glass® head mounted display), a PC, a workstation, a mainframe, a kiosk, a server rack, or any other data processing system.

Due to the ever-changing nature of computers and networks, the description of computer system 1300 depicted in the figure is intended only as a specific example. Many other configurations having more or fewer components than the system depicted in the figure are possible. For example, customized hardware might also be used and/or particular elements might be implemented in hardware, firmware, software (including applets), or a combination. Further, connection to other computing devices, such as network input/output devices, may be employed. Based on the disclosure and teachings provided herein, a person of ordinary skill in the art will appreciate other ways and/or methods to implement the various embodiments.

Although specific embodiments have been described, various modifications, alterations, alternative constructions, and equivalents are also encompassed within the scope of the disclosure. Embodiments are not restricted to operation within certain specific data processing environments, but are free to operate within a plurality of data processing environments. Additionally, although embodiments have been described using a particular series of transactions and steps, it should be apparent to those skilled in the art that the scope of the present disclosure is not limited to the described series of transactions and steps. Various features and aspects of the above-described embodiments may be used individually or jointly.

Further, while embodiments have been described using a particular combination of hardware and software, it should be recognized that other combinations of hardware and software are also within the scope of the present disclosure. Embodiments may be implemented only in hardware, or only in software, or using combinations thereof. The various processes described herein can be implemented on the same processor or different processors in any combination. Accordingly, where components or services are described as being configured to perform certain operations, such configuration can be accomplished, e.g., by designing electronic circuits to perform the operation, by programming programmable electronic circuits (such as microprocessors) to perform the operation, or any combination thereof. Processes can communicate using a variety of techniques including but not limited to conventional techniques for inter process communication, and different pairs of processes may use different techniques, or the same pair of processes may use different techniques at different times.

The specification and drawings are, accordingly, to be regarded in an illustrative rather than a restrictive sense. It will, however, be evident that additions, subtractions, deletions, and other modifications and changes may be made thereunto without departing from the broader spirit and scope as set forth in the claims. Thus, although specific disclosure embodiments have been described, these are not intended to be limiting. Various modifications and equivalents are within the scope of the following claims.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments and does not pose a limitation on the scope of the disclosure unless otherwise claimed. No language in the specification should be construed as indicating any non-claimed element as essential to the practice of the disclosure.

Disjunctive language such as the phrase “at least one of X, Y, or Z,” unless specifically stated otherwise, is intended to be understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Preferred embodiments of this disclosure are described herein, including the best mode known for carrying out the disclosure. Variations of those preferred embodiments may become apparent to those of ordinary skill in the art upon reading the foregoing description. Those of ordinary skill should be able to employ such variations as appropriate and the disclosure may be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein.

All references, including publications, patent applications, and patents, cited herein are hereby incorporated by reference to the same extent as if each reference were individually and specifically indicated to be incorporated by reference and were set forth in its entirety herein.

In the foregoing specification, aspects of the disclosure are described with reference to specific embodiments thereof, but those skilled in the art will recognize that the disclosure is not limited thereto. Various features and aspects of the above-described disclosure may be used individually or jointly. Further, embodiments can be utilized in any number of environments and applications beyond those described herein without departing from the broader spirit and scope of the specification. The specification and drawings are, accordingly, to be regarded as illustrative rather than restrictive.

What is claimed is:

1. A method comprising:
receiving, by a computing device, an accuracy target for one or more machine learning models;
training, by the computing device, the one or more machine learning models on a labeled training set of labeled data;
until the accuracy of the one or more machine learning models satisfies the accuracy target:
sampling, by the computing device, a set of unlabeled data to obtain a random training set of unlabeled data;
labeling, by the computing device and using the one or more machine learning models, the random training set of unlabeled data to produce a pseudo labeled training set;
correcting, by the computing device, the labels on a random subset of the pseudo labeled training set;
training, by the computing device, the one or more machine learning models on the labeled training set, the corrected random subset, and the pseudo labeled training set; and
evaluating, by the computing device, the accuracy of the one or more machine learning models using an evaluation set of labeled data; and
deploying, by the computing device, the one or more machine learning models based at least in part on the accuracy of the one or more machine learning models satisfying the accuracy target based at least in part on the evaluating.

2. The method of claim 1, wherein the accuracy target comprises a threshold determined based at least in part on a performance of the one or more machine learning models in classifying unlabeled data.

3. The method of claim 1, wherein the labeling comprises ensemble learning with multiple machine learning models.

4. The method of claim 3, wherein ensemble learning comprises at least one of bagging, stacking, or boosting.

5. The method of claim 1, wherein the labeling comprises test time augmentation with at least one of vertical/horizontal flipping, blurring, random cropping, or histogram equalization.

6. The method of claim 1, wherein the evaluating further comprises:
identifying a performance deficiency where the accuracy of the one or more models in classifying a class of unlabeled data is below a threshold; and
augmenting the random subset of the pseudo labeled training set with a targeted subset comprising data from the pseudo labeled training set that are labeled with the class.

7. The method of claim 1, wherein the labeled training set of labeled data is smaller than the pseudo labeled training set so that a small amount of labeled data can be used to create a larger pseudo labeled training set.

8. A non-transitory computer-readable medium storing a plurality of instructions that when executed control a computer system to perform operations comprising:
receiving, by a computing device, an accuracy target for one or more machine learning models;
training, by the computing device, the one or more machine learning models on a labeled training set of labeled data;
until the accuracy of the one or more machine learning models satisfies the accuracy target:
sampling, by the computing device, a set of unlabeled data to obtain a random training set of unlabeled data;
labeling, by the computing device and using the one or more machine learning models, the random training set of unlabeled data to produce a pseudo labeled training set;
correcting, by the computing device, the labels on a random subset of the pseudo labeled training set;
training, by the computing device, the one or more machine learning models on the labeled training set, the corrected random subset, and the pseudo labeled training set; and
evaluating, by the computing device, the accuracy of the one or more machine learning models using an evaluation set of labeled data; and
deploying, by the computing device, the one or more machine learning models based at least in part on the accuracy of the one or more machine learning models satisfying the accuracy target based at least in part on the evaluating.

9. The non-transitory computer readable medium of claim 8, wherein the accuracy target comprises a threshold determined based at least in part on a performance of the one or more machine learning models in classifying unlabeled data.

10. The non-transitory computer readable medium of claim 8, wherein the labeling comprises ensemble learning with multiple machine learning models.

11. The non-transitory computer readable medium of claim 10, wherein ensemble learning comprises at least one of bagging, stacking, or boosting.

12. The non-transitory computer readable medium of claim 8, wherein the labeling comprises test time augmentation with at least one of vertical/horizontal flipping, blurring, random cropping, or histogram equalization.

13. The non-transitory computer readable medium of claim 8, wherein the evaluating further comprises:
identifying a performance deficiency where the accuracy of the one or more models in classifying a class of unlabeled data is below a threshold; and
augmenting the random subset of the pseudo labeled training set with a targeted subset comprising data from the pseudo labeled training set that are labeled with the class.

14. The non-transitory computer readable medium of claim 8, wherein the labeled training set of labeled data is smaller than the pseudo labeled training set so that a small amount of labeled data can be used to create a larger pseudo labeled training set.

15. A system comprising:
a computer-readable medium; and
one or more processors for executing instructions stored on the computer-readable medium to at least perform operations comprising:
receiving, by a computing device, an accuracy target for one or more machine learning models;
training, by the computing device, the one or more machine learning models on a labeled training set of labeled data;
until the accuracy of the one or more machine learning models satisfies the accuracy target:
sampling, by the computing device, a set of unlabeled data to obtain a random training set of unlabeled data;
labeling, by the computing device and using the one or more machine learning models, the random training set of unlabeled data to produce a pseudo labeled training set;
correcting, by the computing device, the labels on a random subset of the pseudo labeled training set;
training, by the computing device, the one or more machine learning models on the labeled training set, the corrected random subset, and the pseudo labeled training set; and
evaluating, by the computing device, the accuracy of the one or more machine learning models using an evaluation set of labeled data; and
deploying, by the computing device, the one or more machine learning models based at least in part on the accuracy of the one or more machine learning models satisfying the accuracy target based at least in part on the evaluating.

16. The system of claim 15, wherein the accuracy target comprises a threshold determined based at least in part on a performance of the one or more machine learning models in classifying unlabeled data.

17. The system of claim 15, wherein the labeling comprises ensemble learning with multiple machine learning models.

18. The system of claim 17, wherein ensemble learning comprises at least one of bagging, stacking, or boosting.

19. The system of claim 15, wherein the labeling comprises test time augmentation with at least one of vertical/horizontal flipping, blurring, random cropping, or histogram equalization.

20. The system of claim 15, wherein the evaluating further comprises:
identifying a performance deficiency where the accuracy of the one or more models in classifying a class of unlabeled data is below a threshold; and
augmenting the random subset of the pseudo labeled training set with a targeted subset comprising data from the pseudo labeled training set that are labeled with the class.
